(19) United States
(12) Patent Application Publication
(10) Pub. No.: US 2012/0221249 A1
(43) Pub. Date: Aug. 30, 2012

(54) Long Hepitype Distribution (LHD)

(75) Inventors: Paul M. Lizardi, Wallingford, CT (US); Junhyong Kim, Narberth, PA (US)

(73) Assignee: The Trustees of The Uniiversity of Pennsylvania

(21) Appl. No.: 13/320,590

(22) PCT Filed: May 14, 2010
(86) PCT No.: PCT/US10/34970

§ 371 Date: May 15, 2012

Related U.S. Application Data
(60) Provisional application No. 61/178,764, filed on May 15, 2009.

(51) Int. Cl. G06F 19/20

(52) U.S. Cl. 702/19

(57) ABSTRACT

The invention includes a method of creating a sequence information framework that defines the range of epigenetic configurations of individual DNA strands in any diploid organism in which DNA methylation is prevalent. The invention also includes a method of generating DNA descriptors referred to as long hepitype distributions (LHDs).

### BACKGROUND OF THE INVENTION

Polymorphisms are allelic variants that occur in a population. A single nucleotide polymorphism (SNP) is a position in a particular DNA sequence characterized by the presence in a population of two, three or four different nucleotides at that position. The most common SNPs have two different nucleotides and are thus biallelic. Identification of SNPs associated with disease susceptibility is invaluable for screening and early initiation of prophylactic treatments.

There is a need in the art for defining the structural variation that occurs in cells of living organisms at the level of individual chromosomes. In human genetics, the concept of a SNP haplotype refers to a set SNPs that are statistically associated and therefore behave as a single unit of inheritance. It is thought that these associations, and the identification of a few alleles of a haplotype block, may unambiguously identify all other polymorphic sites in its region. Such information is very valuable for investigating the genetics behind common diseases and is collected by the International HapMap Project. A haplotype block is a set of “s” consecutive SNPs, which, although in theory could generate as many as 2^{s} different haplotypes, in fact shows markedly fewer in an experimental sample of “n” DNA sequences from several individuals, perhaps as few as “s+1”. The length of different haplotype blocks in the human genome ranges from 5 Kb to approximately 200 Kb. FIG. 1, taken from a paper by Gabriel et al. (2002), illustrates a histogram (3B) of the proportion of genome sequence belonging to each block size.

In a recent review (Butcher & Beck, 2008), problems with current genome-wide association studies (GWAS) that focus on complex diseases were discussed. The authors discussed the well-known fact that the statistical power derived from combinations of SNPs that are associated with disease phenotypes is low because the biological effects generated by a single SNP is small. For example, the SNPs that have been found to be associated with type II diabetes, an exemplary complex disease, may account for only a small fraction of the phenotypic variation observed in individuals with the disease.

The human genome contains approximately 40 million methylated cytosine (5-methylcytosine) bases, which are followed immediately by a guanine residue in the DNA sequence, with CpG dinucleotides comprising about 1.4% of the entire genome. An unusually high proportion of these bases is located in the regulatory and coding regions of genes. Methylation of cytosine residues in DNA is currently thought to play a direct role in controlling normal cellular development. Various studies have demonstrated that a close correlation exists between methylation and transcriptional inactivation. Regions of DNA that are actively engaged in transcription, however, lack 5-methylcytosine residues.

Methylation patterns, comprising multiple CpG dinucleotides, also correlate with gene expression, as well as with the phenotype of many of the most important common and complex human diseases. Methylation positions have, for example, not only been identified that correlate with cancer, as has been corroborated by many publications, but also with diabetes type II, arteriosclerosis, rheumatoid arthritis, and disease of the CNS. Likewise, methylation at other positions correlates with age, gender, nutrition, drug use, and probably a whole range of other environmental influences. Methylation is the only flexible (reversible) genomic parameter under exogenous influence that may change genome function, and hence constitutes the main (and so far missing) link between the genetics of disease and the environmental components that are widely acknowledged to play a decisive role in the etiology of virtually all human pathologies that are the focus of current biomedical research.

Methylation plays an important role in disease analysis because methylation positions vary as a function of a variety of different fundamental cellular processes. Additionally, however, many positions are methylated in a stochastic way, that does not contribute any relevant information.

Butcher and Beck discussed how gene-environment interactions are not taken into account in most GWAS studies, and how these environmental covariables could in principle be utilized to increase the power of future GAWS studies focusing on complex disease. They then reviewed the concepts of the “epitype” and the “hepitype” (Murrell et. al, 2005), which refer either to base level or to haplotype-level variation that may be observed using experimental data that reveals the status of DNA methylation at cytosine residues. For about 30% of genes, epitypes and hepitypes may carry information relevant to whether the gene is active or inactive, and hence may be used for “reverse genotyping”. Murrell and coworkers also introduced in 2005 the concept of the MVP (methylation variable position), which refers to the subset of methylated positions (epitypes) that contain information that is biologically relevant. The human genome contains 26.9 million potentially methylatable cytosines, and hence the total number of MVPs is probably of the order of 5 million.

Butcher and Beck discussed that future GWAS studies that do take into account MVP information may succeed while relying on fewer case and control samples. This is extremely important, as current estimates of the size of GWAS studies based only on SNPs indicated that certain diseases may require the use of as many as 30,000 to 100,000 cases and controls (Altshuler et al., 2008), with dismal implications as to the potential cost of such studies. Thus, MVP information could significantly reduce the cost of GWAS projects.

The present invention addresses an unmet need for sequence descriptors of biological information that occurs at the level of epigenetic variation in DNA chemistry. By addressing this need and generating new information, the invention provides a new set of practical applications in the fields of human genetics, reproductive biology, animal breeding, environmental science, cancer risk assessment, quantitative aging assessment, assessment of immune disregulation or neurodegeneration, and drug development, among others.

### BRIEF SUMMARY OF THE INVENTION

The invention provides a method of generating a long hepitype distribution (LHD). The method comprises the steps of obtaining a biological sample having genomic DNA; obtaining the DNA from the sample; obtaining and analyzing a DNA sequence that includes the information of methylated bases in the DNA; repeating the DNA sequence analysis multiple times; and aligning a multiplicity of sequences with reference to variable bits of DNA methylation information, thereby generating one or more alignments, which collectively may be used to calculate statistics that describe a LHD.

In one embodiment, the methylated DNA sequences are larger than 3 kilobases.

In another embodiment, the probabilities of the presence or absence of methylated bases is described using markov chain statistics.

In one embodiment, the LHD comprises a group of sequence strings, wherein the group of sequence strings comprises DNA methylation and SNP information.

The invention provides a method of generating a haplotype block long hepitype distribution comprising extending an LDH until the length of the groups of aligned sequences approaches the length of an SNP haplotype block present at the corresponding genomic locus, wherein the LDH comprises a group of sequence strings, further wherein the group of sequence strings comprises DNA methylation and SNP information.

The invention provides a diagnostic method for determining heterogeneity of a biological sample comprising generating an LHD from a first and second biological sample, wherein the LHD comprises a group of sequence strings comprising DNA methylation and SNP information; comparing LHD from the first sample to LHD of the second sample, wherein a change of the methylation in the LHD from the first sample when compared with the LHD from the second sample indicates heterogeneity.

In one embodiment, the biological sample is a cell. In another embodiment, the cell is a zygote. In yet another embodiment, the zygote is an egg or sperm.

In one embodiment, the biological sample is a tissue.

The method provides a method of determining heterogeneity of a biological sample. The method comprises the step of analyzing a large dataset from which different holocomplement components may be analyzed, wherein analyzing a large dataset comprises constructing individual holocomplements from sequence data and a multiplicity of LHD data structures obtained from a biological sample. The method further comprises the step of applying a maximum parsimony approach to deduce correlations among fractional states of genome-wide hepitype frequencies, thereby determining heterogeneity of a biological sample.

In one embodiment, the analysis further includes phylogenetic tree analysis of methylation string bits from DNA sequences from different loci.

In another embodiment, the analysis includes correlating data structures among a multiplicity of LHD data structures obtained from one or more biological samples.

In one embodiment, the analysis of the LHD methylation information is used to reveal whether or not a human tissue generated from stem cells or induced pluripotent stem (iPS) cells is in the specific, desired developmental state characteristic of a normal human tissue sample.

In one embodiment, the analysis of the LHD methylation and SNP information is used to reveal whether or not a human tissue generated from stem cells or iPS cells is in the specific, desired developmental state characteristic of a normal human tissue sample with a similar germline haplotype structure.

In one embodiment, the analysis of the LHD methylation and SNP information is used to reveal the rich heterogeneity of normal or diseased neural tissue, by employing a ternary data representation in a markov model for the methylation status of cytosines, in order to enable the LHD analysis of brain DNA containing cytosine, 5-methylcytosine as well as 5-hydroxymethylcytosine.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1, comprising FIGS. 1A through 1D, is a series of images illustrating proportion of all genome sequence spanned by haplotype blocks of different size. FIG. 1 is taken from Gabriel et al. (2002).

FIG. 2 is an image illustrating exemplary hepitypes within a SNP locus.

FIG. 3 is an image illustrating assembly of four different exemplary hepitypes, belonging to two different SNP haplotypes, by alignment of 10 strings generated by bisulfite DNA sequencing. The alignment makes use of 2 Bits of information corresponding to methylated cytosines.

FIG. 4 is an image illustrating the association of different levels of DNA methylation with a SNP polymorphism in the cadherin 13 (CDH13) gene. FIG. 4 is taken from Flanagan et al., which illustrating exemplary short hepitypes.

FIG. 5 is an image illustrating apparent association of different levels of DNA methylation with a SNP polymorphism. FIG. 5 is taken from Philibert et. al., which illustrating the relationship between the average methylation and 5HTTLPR genotype.

FIG. 6 is an image illustrating patterns of DNA methylation at the MAGEB2 promoter after treatment with various drugs. FIG. 6 is taken from Milutinovic et al., which illustrating bisulfite mapping of CG sites in the MAGEB2 promoter.

FIG. 7 is an image illustrating an exemplary mosaic pattern of DNA methylation correlates with a SNP located upstream of the MSH2 promoter in families with high incidence of colon cancer. FIG. 7 is taken from Chan et al.

FIG. 8 is an image illustrating a pattern of DNA methylation strings in adipose stem cells (ASC) sorted for CD31− (panel B) or CD31+ (panel C) phenotype. FIG. 8 is taken from Boquest et al.

FIG. 9 is an image illustrating a pattern of DNA methylation strings in adipose stem cells (ASC) in the undifferentiated state (panel A), or after induction of differentiation (A), or after complete differentiation (E). FIG. 9 is taken from Bequest et al.

FIG. 10 is an image illustrating changes in mRNA expression levels in mice made obese by a high-fat diet. The histogram labeled leptin shows an increase in expression of about 2.4 fold, and the histogram labeled MMP2 (matrix metalloprotease) an increase of about 4-fold. FIG. 10 is taken from Hosogai et al.

FIG. 11 is a graph illustrating fraction of genes with “Incomplete assembly”. The curve shows a decrease in the failure rate of long hepitype string discrimination based on cytosine methylation information, as the DNA sequencing read length increases.

### DETAILED DESCRIPTION OF THE INVENTION

The present invention provides methods and compositions to create a sequence information framework that defines the range of epigenetic configurations of individual DNA strands in any organism in which DNA methylation is prevalent.

The invention includes a method for generating DNA descriptors referred to as long hepitype distributions (LHDs). LHDs integrate several different types of information: (a) DNA locus information; (b) DNA sequence information; (c) Single Nucleotide Polymorphism information; and (d) DNA methylation information. The DNA methylation distribution encapsulated by each member of any given LHD belonging to a specific locus in the genome describes the possible states of a haplotype block at the epigenetic level, whereby each haplotype block may exist in one, or more alternative epigenetic configurations, called “long hepitypes”.

A multiplicity of LHDs may be generated by DNA methylation analysis of a large portion of the genome, preferably the human genome. When a large set of LHDs is available, the analysis of statistical correlations among LHDs, as well as the analysis of interactions between genes associated with each LHD, may lead to important insights about the regulatory states of individual subsets of cells in tissue. For example, each subset of cells may harbor a holocomplement of hepytypes. A holocomplement is the collection of all the co-resident hepitypes in a diploid chromosome complement.

Individual holocomplements may be constructed from sequence data and a multiplicity of LHD data structures obtained from a mixture of cells where different cell populations contribute to different holocomplements.

The information generated from LHD structures also provides a novel resource for the understanding of fundamental biological processes such as gene regulation, imprinting of genes, development, genome stability, disease susceptibility and the interplay of genetics and environment.

### DEFINITIONS

As used herein, each of the following terms has the meaning associated with it in this section.

The articles “a” and “an” are used herein to refer to one or to more than one (i.e. to at least one) of the grammatical object of the article. By way of example, “an element” means one element or more than one element.

The term “abnormal” when used in the context of organisms, tissues, cells or components thereof, refers to those organisms, tissues, cells or components thereof that differ in at least one observable or detectable characteristic (e.g., age, treatment, time of day, etc.) from those organisms, tissues, cells or components thereof that display the “normal” (expected) respective characteristic. Characteristics that are normal or expected for one cell or tissue type might be abnormal for a different cell or tissue type.

As used herein, “allele” refers to one or more alternative forms of a particular sequence that contains a SNP. The sequence may or may not be within a gene.

“Amplification” refers to any means by which a polynucleotide sequence is copied and thus expanded into a larger number of polynucleotide sequences, e.g., by reverse transcription, polymerase chain reaction or ligase chain reaction, among others.

The term “bisulfite treatment” as used herein means treatment with a bisulfite, a disulfite, a hydrogensulfite solution, or combinations thereof, useful as disclosed herein to distinguish between methylated and unmethylated bases.

The term “epigenetic” as used herein describes a phenotype end-point due to cellular interactions. Epigenetic also refers to heritable changes in phenotype or gene expression caused by mechanisms other than changes in the underlying DNA sequence.

The term “haplotype” as used herein refers to a combination of alleles at multiple loci that are transmitted together on the same chromosome. Haplotype may also refer to a set of single nucleotide polymorphisms (SNPs) on a single chromatid that are statistically associated. Haplotype may also refer to an individual collection of Short tandem repeat (STR) allele mutations within a genetic segment. Recombinations occur at different frequency in different parts of the genome and, therefore, the length of the haplotypes vary throughout the chromosomal regions and chromosomes. For a specific gene segment, there are often many theoretically possible combinations of SNPs, and therefore there are many theoretically possible haplotypes.

As used herein, a “holocompletnent” is the collection of all the co-resident hepitypes (representing all haplotype blocks) in a diploid chromosome complement, within the nucleus of a single cell, or in a homogeneous population of cells closely related by lineage. In some instances, the holocomplement of each cell gets scrambled during DNA extraction of a tissue sample.

The term “hypermethylation” refers to the average methylation state corresponding to an increased presence of 5-mCyt within a DNA sequence of a test DNA sample, relative to the amount of 5-mCyt found in a corresponding normal control DNA sample.

The term “hypomethylation” refers to the average methylation state corresponding to a decreased presence of 5-mCyt within a DNA sequence of a test DNA sample, relative to the amount of 5-mCyt found in a corresponding normal control DNA sample.

The term “individual” includes human beings and non-human animals, preferably mammals.

As used herein, an “instructional material” includes a publication, a recording, a diagram, or any other medium of expression which may be used to communicate the usefulness of the kit for its designated use in practicing a method of the invention. The instructional material of the kit of the invention may, for example, be affixed to a container which contains the composition or be shipped together with a container which contains the composition. Alternatively, the instructional material may be shipped separately from the container with the intention that the instructional material and the composition be used cooperatively by the recipient.

As used herein, a “long hepitype distribution” (LHD) refers to a set of DNA descriptors. LHDs are descriptors that integrate several different types of information including, but not limited to DNA locus information, DNA sequence information, Single Nucleotide Polymorphism information, and DNA methylation information.

As used herein “long hepitype distribution fluctuations” (LHDf) refers to observations in LHD structures obtained from different tissues or different individuals, or after any sampling based on time or exposure to some agent.

As used herein, “long hepitype distribution resetting” (LHDr) refers to changes generated in LHD structures. In some instances, the observed changes in LHD structures are result of treatment with a drug or a tissue reprogramming agent, in the context of a disease process, or a tissue transplantation or tissue engineering procedure.

As used herein, “single-locus LI-ID” refers to an LHD generated at a single haplotype block in the genome.

As used herein, “set of independent LHDs” refers to a collection of different isolated LHDs generated through the analysis of a plurality of genomic loci that belong to different haplotype blocks.

“Methylation content,” or “5-methylcytosine content,” as used herein refers to the total amount of 5-methylcytosine present in a DNA sample (i.e., a measure of base composition).

“Methylation level” or “methylation degree,” refers to the average amount of methylation present at an individual CpG dinucleotide. Measurement of methylation levels at a plurality of different CpG dinucleotide positions creates either a methylation profile or a methylation pattern.

The term “methylation state” or “methylation status” refers to the presence or absence of 5-methylcytosine (“5-mCyt”) within a DNA sequence. In some instances, the term “methylation state” or “methylation status” refers to the presence or absence of 5-methylcytosine (“5-mCyt”) at one or a plurality of CpG dinucleotides within a DNA sequence. Methylation states at one or more CpG methylation sites within a single allele's DNA sequence include “unmethylated,” “fully-methylated” and “hemi-methylated,”

The term “microarray” refers broadly to both “DNA microarrays” and “DNA chip(s),” and encompasses all art-recognized solid supports, and all art-recognized methods for affixing nucleic acid molecules thereto or for synthesis of nucleic acids thereon.

As used herein, “phenotypically distinct” is used to describe organisms, tissues, cells or components thereof, which may be distinguished by one or more characteristics, observable and/or detectable by current technologies. Each of such characteristics may also be defined as a parameter contributing to the definition of the phenotype. Wherein a phenotype is defined by one or more parameters an organism that does not conform to one or more of the parameters shall be defined to be distinct or distinguishable from organisms of the said phenotype.

“Parsimony” as used herein refers to a non-parametric statistical method commonly used in computational phylogenetics for estimating phylogenies. Under parsimony, the preferred phylogenetic tree is the tree that requires the least evolutionary change to explain some observed data. Parsimony is part of a class of character-based tree estimation methods which use a matrix of discrete phylogenetic characters to infer one or more optimal phylogenetic trees for a set of taxa, commonly a set of species or reproductively-isolated populations of a single species. These methods operate by evaluating candidate phylogenetic trees according to an explicit optimality criterion; the tree with the most favorable score is taken as the best estimate of the phylogenetic relationships of the included taxa.

The term “tissue marker” refers to a distinguishing or characteristic substance that may be found in blood or other bodily fluids, but mainly in cells of specific tissues. The substance may for example be a protein, an enzyme, a RNA molecule or a DNA molecule. The term may alternately refer to a specific characteristic of the substance, such as but not limited to a specific methylation pattern, making the substance distinguishable from otherwise identical substances. A high level of a tissue marker found in a cell may mean the cell is a cell of that respective tissue. A high level of a tissue marker found in a bodily fluid may mean that a respective type of tissue is either spreading cells that contain the marker into the bodily fluid, or is spreading the marker itself into the blood or other bodily fluids.

In the context of the present invention, the following abbreviations for the commonly occurring nucleic acid bases are used. “A” refers to adenosine, “C” refers to cytidine, “G” refers to guanosine, “T” refers to thymidine, and “U” refers to uridine.

The term “nucleic acid” refers to deoxyribonucleotides or ribonucleotides and polymers thereof in either single- or double-stranded form, made of monomers (nucleotides) containing a sugar, phosphate and a base that is either a purine or pyrimidine. The term encompasses nucleic acids containing known analogs of natural nucleotides that have similar binding properties as the reference nucleic acid and are metabolized in a manner similar to naturally occurring nucleotides. A nucleic acid sequence may also encompass conservatively modified variants thereof (e.g., degenerate codon substitutions) and complementary sequences, as well as the sequence explicitly indicated.

A “polynucleotide” means a single strand or parallel and anti-parallel strands of a nucleic acid. Thus, a polynucleotide may be either a single-stranded or a double-stranded nucleic acid. A polynucleotide is not defined by length and thus includes very large nucleic acids, as well as short ones, such as an oligonucleotide.

The term “oligonucleotide” typically refers to short polynucleotides, generally no greater than about 50 nucleotides. It will be understood that when a nucleotide sequence is represented by a DNA sequence (i.e., A, T, G, C), this also includes an RNA sequence (i.e., A, U, G, C) in which “U” replaces “T.”

Conventional notation is used herein to describe polynucleotide sequences: the left-hand end of a single-stranded polynucleotide sequence is the 5′-end; the left-hand direction of a double-stranded polynucleotide sequence is referred to as the 5′-direction.

The direction of 5′ to 3′ addition of nucleotides to nascent RNA transcripts is referred to as the transcription direction. The DNA strand having the same sequence as an mRNA is referred to as the “coding strand”. Sequences on a DNA strand which are located 5′ to a reference point on the DNA are referred to as “upstream sequences”. Sequences on a DNA strand which are 3′ to a reference point on the DNA are referred to as “downstream sequences,”

Certain embodiments of the invention encompass isolated or substantially purified nucleic acid compositions. In the context of the present invention, an “isolated” or “purified” DNA molecule or RNA molecule is a DNA molecule or RNA molecule that exists apart from its native environment and is therefore not a product of nature. An isolated DNA molecule or RNA molecule may exist in a purified form or may exist in a non-native environment such as, for example, a transgenic host cell. For example, an “isolated” or “purified” nucleic acid molecule, is substantially free of other cellular material, or culture medium when produced by recombinant techniques, or substantially free of chemical precursors or other chemicals when chemically synthesized. In one embodiment, an “isolated” nucleic acid is free of sequences that naturally flank the nucleic acid (i.e., sequences located at the 5′ and 3′ ends of the nucleic acid) in the genomic DNA of the organism from which the nucleic acid is derived.

The term “gene” is used broadly to refer to any segment of nucleic acid associated with a biological function. Thus, genes include coding sequences and/or the regulatory sequences required for their expression. For example, “gene” refers to a nucleic acid fragment that expresses mRNA, functional RNA, or specific protein, including regulatory sequences. “Genes” also include non-expressed DNA segments that, for example, form recognition sequences for other proteins. “Genes” may be obtained from a variety of sources, including cloning from a source of interest or synthesizing from known or predicted sequence information, and may include sequences designed to have desired parameters.

“Naturally occurring” as used herein describes a composition that may be found in nature as distinct from being artificially produced. For example, a nucleotide sequence present in an organism, which may be isolated from a source in nature and which has not been intentionally modified by a person in the laboratory, is naturally occurring.

“Regulatory sequences” and “suitable regulatory sequences” each refer to nucleotide sequences located upstream (5′ non-coding sequences), within, or downstream (3′ non-coding sequences) of a coding sequence, and which influence the transcription, RNA processing or stability, or translation of the associated coding sequence. Regulatory sequences include enhancers, promoters, translation leader sequences, introns, and polyadenylation signal sequences. They include natural and synthetic sequences as well as sequences that may be a combination of synthetic and natural sequences.

A “5′ non-coding sequence” refers to a nucleotide sequence located 5′ (upstream) to the coding sequence. It is present in the fully processed mRNA upstream of the initiation codon and may affect processing of the primary transcript to mRNA, mRNA stability or translation efficiency.

A “3′ non-coding sequence” refers to nucleotide sequences located 3′ (downstream) to a coding sequence and may include polyadenylation signal sequences and other sequences encoding regulatory signals capable of affecting mRNA processing or gene expression. The polyadenylation signal is usually characterized by affecting the addition of polyadenylic acid tracts to the 3′ end of the mRNA precursor.

### Description

The invention generally relates to a type of epigenetic analysis. Specifically, the invention relates to a method of building a DNA sequence structure, referred to as a long hepitype distribution (LHD). LHDs may be generated using sequence alignments in reference to highly correlated patterns of DNA methylation frequencies. A sequence alignment is used as a device to make the methylation patterns grow longer, and as they grow longer their information content increases. Thus, in some aspects, LHD may be considered an information-maximization bioinformatics construct.

In one embodiment, the invention provides a means to address the problem of generating DNA methylation descriptors for samples that may contain heterogeneity in DNA methylation. In some instances, LHD provides a type of epigenetic analysis useful for addressing heterogeneity in DNA methylation in a tissue sample. In other instances, LHD is useful for addressing heterogeneity in DNA methylation that is inherent in having two different autosomes within each cell.

In some instances, LHD analysis is not performed using simple averaging. Rather, methylation profiles corresponding to LHD are calculated as distributions of variables. In some instances, the distributions are calculated using Markov chain statistics.

In some instances, LHD analysis is associated with much longer distances than 3 kb. Thus, methylation patterns in LHD are much longer and contain a much larger amount of information, including single chromatid linkage information and cell type heterogeneity information.

### Compositions

The present invention provides a sequence descriptor of biological information that occurs at the level of epigenetic variation in DNA chemistry, termed long hepitype distributions (LHD). LHDs are information-rich structures that may be constructed using string alignment tools, making use of DNA methylation information obtained by a multiplicity of DNA sequencing reads.

LHDs represent a type of information obtained from aligning DNA methylated sequences. For example, DNA sequence generated using the sodium bisulfite methodology provides for methylated sequence information because sodium bisulfite selectively converts cytosine to uracyl, while methylated cytosine is unchanged, and therefore is interpreted as methylated bases.

The alignment of different sequences is performed taking advantage of the methylated cytosine information, designated as for example, Bit 1, Bit 2, etc. From the alignment, the most likely sequence configurations may be inferred, corresponding to the first SNP, the second SNP, and so on. As discussed more fully in the Examples, the structure of a hepitype is not deterministic (as with haplotype blocks) but probabilistic, as evidenced by individual strand variation in different designated hepitypes.

While the phenotype of an individual is easily described for those traits that are a property of an easily visible structure, like the color of hair, or the color of eyes, there exist other phenotypes that are more difficult to describe. For example, the odor sensitivity phenotype is complex, because there is a very large set of odorants that in principle could be tested, and the tissue structures responsible for the response comprise an array of thousands of different cells (neurons) with different odorant response properties. Behavioral phenotypes represent an even more complex example, where multiple subtle phenotypes may be assessed, and for each trait the brain tissue responsible for the phenotype comprises heterogeneous cell types and a myriad of connections among them. LHDs provide information that is useful in correlating these types of phenotypes with at least DNA methylation patterns.

There is considerable evidence suggesting that DNA methylation information may encode information relevant to: (1) establishment and maintenance of lineages; (2) establishment of “chromatin states” that may relate to transcriptional activity; and (3) shifts (loss of stability) due to aging, stress, inflammation, or environmental insults.

The three types of information listed above, lineage establishment, specific transcriptional states, as well as loss of stability of a lineage specifier or a transcriptional state specifier, represent an information hierarchy that constitutes a powerful descriptor of cellular phenotype, especially when heterogenous phenotypes are present. LHDs may encapsulate all three types of information. Thus a long hepitype encompassing an entire 100 Kb gene locus may contain a subset of “flipped bits” indicative of lineage membership, while other “flipped bits” may indicate a silenced state of the locus. In some instances, LHDs may contain yet another set of bits that may reveal a subset of cells where the “normal” methylated, silenced state, has given way to a demethylated, partially active state. For any subset of cells that displays a different phenotypic state relative to the rest of the tissue, a long hepitype may provide a quantitative metric of tissue mosaicism that may be crucial for understanding a complex disease process.

Long hepitype distribution information is distinguishable from local (short) DNA methylation information because, unlike the latter, it contains genetic linkage information descriptive of an entire structural locus, and encompasses the information hierarchies including, but not limited to lineage establishment, specific transcriptional states, as well as loss of stability of a lineage specifier or a transcriptional state specifier. A local (short) DNA methylation patterns does not encapsulate as much information as LHDs because local (short) DNA methylation patterns are unlinked from neighboring information-containing DNA sequence elements.

The discovery of genetic traits associated with risk of disease may be performed with greater power by using haplotype block information. When plotting Linkage Disequilibrum (LD) across the human genome, the treatment of a block of single SNPs as a single allele, if used correctly, may result in a reduction in noise, and therefore detection of small association effects. For example, one 84 kb block of 8 SNPs may show just two distinct haplotypes accounting for 95% of the observed chromosome sequences, and these two haplotypes yield association data with lower noise than 8 SNPs individually. LHDs may likewise reduce informational noise in epigenetic association studies. Thus, LHDs may be considered as a framework where epigenetic information may be “aggregated” in a manner that reduces the number of data vectors, but does so without averaging potentially informative differences among individual cells. Accordingly, an advantage of LHD structures over the art is that LHD structures make DNA methylation information less “noisy” and therefore may detect even small association effects.

Another advantage of LHD data structures is that they create a formalism that joins multiple alternative epigenetic phenotypes with each haplotype block, so as to expand each block's power as a quantitative trait locus (QTL) in association studies.

Other advantages of MD information is that it is informative with respect to levels of tissue heterogeneity. LHD information is also informative as to the current state of differentiation or the abnormal loss of differentiation in tissues. LHD information may also be informative as to mitotic age of cells in tissue. LHD information may also serve as a time-indexed archive of stressful environmental exposures.

In diseases that manifest themselves with increased frequency in old age, such as metabolic syndrome or dementias, the variation in properties of individual haplotypes within individual cells, as represented by LHDs, become important. The LHD data structures allows phenotype to be defined cell-by-cell, often including information bits about lineage, mitotic age and environmental insults recorded in the DNA strand hepitype phylogenies as regulated epigenetic variation, or disturbance-induced noise.

Thus, the present invention provides not only a method for the comprehensive identification of regions in the genome that are useful markers, but also provides the tools (e.g., the marker nucleic acids and their tissue specific methylation patterns), to identify the organ, tissue or cell type source of the analyzed genomic DNA.

### Methods

The methods of the invention comprise generating DNA descriptors called long hepitype distributions (LHDs). In one embodiment, the present invention provides a method for constructing a DNA descriptor where analysis of gene expression (e.g., of RNA, cDNA or protein) is not a requirement for creating the descriptor.

The present invention provides novel methods not only for determining qualitative information for generating methylation profiles, but also for determining quantitative methylation patterns. The inventive methods provide quantitative information on methylation levels of cytosines within the genome of interest.

In one embodiment, the information generated from LHD structures allows for the correlations between specific methylation patterns and phenotypes such as age, gender or disease, as well as correlations between specific methylation patterns and different cell, tissue or organ types. The information generated from LHD structures also provides a novel resource for the understanding of fundamental biological processes such as gene regulation, imprinting of genes, development, genome stability, disease susceptibility and the interplay of genetics and environment. Moreover, such knowledge may be used to assess if and how methylation patterns respond to environmental influences, such as nutrition, or smoking, etc.

Moreover, the present invention enables correlations of DNA-methylation patterns with parameters such as tumorigenesis, progression and metastasis, stem cells and differentiation, proliferation and cell cycle, diseases and disorders, and metabolism to be generated.

The present invention provides a method for generating LHDs comprising: obtaining, a biological sample having genomic DNA; pretreating the genomic DNA of the sample by contacting the sample, or isolated DNA from the sample, with an agent, or series of agents that modifies unmethylated cytosine but leaves methylated cytosine essentially unmodified; sequencing the pretreated nucleic acids; analyzing the sequences to quantify a level of methylation; creation of hepitype distribution by aligning the sequences with reference to the methylated cytosine information.

More specifically, DNA is sequenced using any method that yields individual DNA strand information about the specific positions of methylated bases in DNA. These sequences are referred to as “DNA methylation sequences”. A multiplicity of DNA methylation sequences are aligned, using the bits of DNA methylation information to guide the alignment. Any DNA sequence alignment method may be used. The alignment process is continued using available sequence information until the alignments are as long as the haplotype blocks encompassing sets of different SNPs.

The alignment are separated into clusters using the following criteria: a) If different SNPs are present, they have precedence for splitting the alignment into clusters; b) following SNP-precendence-clustering, sub-clusters are generated based on the dendrogram structure of the sequence alignment.

The preferred data used to generate LHDs is long-read DNA sequencing based on sodium bisulfate conversion of cytosine (and not methyl-cytosine), or, alternatively, enzymatic conversion of cytosine (and not methyl-cytosine). In some instances, a sequence alignment is used as a device to generate the DNA methylation information as a string of optimal length, which may cover distances as long as 200 kilobases, or more preferred 500 kilobases, or even more preferred 1000 kilobases, or at best the entire length of a chromosome arm, by joining the information derived from DNA sequencing reads just a few thousand bases in length. In other instances, such as when the DNA methylation data is generated by an ultra-long sequence read technology, there may be no need to perform sequence alignment. Thus, if DNA methylation information may be obtained directly as reads exceeding 20,000 bases, one may opt to avoid the sequence alignment steps, in order to generate simpler LHD statistics for this specific length. However, alignment of multiple long sequence reads will always yield LHDs with a larger amount of linkage information.

A. Biological Sample

Biological samples useful in the practice of the methods of the invention may be any biological sample from which any form of DNA may be isolated. Suitable biological samples include, but are not limited to, blood, buccal swabs, hair, bone, and tissue samples, such as skin or biopsy samples. Preferably, the biological sample type is of a tissue, organ or cell.

DNA may isolated from the biological sample by conventional means known to the skilled artisan. See, for instance, Sambrook et al. (2001, Molecular Cloning: A Laboratory Manual, Cold Spring Harbor Laboratory Press, Cold Spring Harbor, N.Y.) and Ausubel et al. (eds., 1997, Current Protocols in Molecular Biology, John Wiley & Sons, New York).

Preferably, genomic DNA is used because analysis of genomic DNA bears the advantage of being a reliable method based on a rather robust material, that is much less sensitive to temperature changes and other environmental influences. Accordingly, embodiments of the present invention are based on the relatively stable DNA molecule, rather than on easily degradable RNA molecules, and the methylation status of the DNA molecule.

B. Methods for Determining Methylation

In higher order eukaryotes, DNA is methylated nearly exclusively at cytosines located 5′ to guanine in the CpG dinucleotide. This modification has important regulatory effects on gene expression, especially when involving CpG rich areas, known as CpG islands, located in the promoter regions of many genes. While almost all gene-associated islands are protected from methylation on autosomal chromosomes, extensive methylation of CpG islands has been associated with transcriptional inactivation of selected imprinted genes and genes on the inactive X-chromosome of females.

The cytosine's modification in form of methylation contains significant information. The identification of 5-methylcytosine in a DNA sequence as opposed to unmethylated cytosine is of importance to analyze its role. However, because the 5-methylcytosine behaves just as a cytosine for what concerns its hybridization preference (a property relied on for sequence analysis) its position cannot be identified by a normal sequencing reaction.

Usually genomic DNA is treated with a chemical or enzyme leading to a conversion of the cytosine bases, which consequently allows to differentiate the bases afterwards. The most common methods are a) the use of methylation sensitive restriction enzymes capable of differentiating between methylated and unmethylated DNA and b) the treatment with bisulfite. Preferably, only sequencing-based methods for detecting DNA methylation may be used in the methods of the present invention.

The quantity of methylation of a locus of DNA may be determined by providing a sample of genomic DNA comprising the locus, cleaving the DNA with a restriction enzyme that is either methylation-sensitive or methylation-dependent, and then quantifying the amount of intact DNA or quantifying the amount of cut DNA at the DNA locus of interest. The amount of intact or cut DNA will depend on the initial amount of genomic DNA containing the locus, the amount of methylation in the locus, and the number (i.e., the fraction) of nucleotides in the locus that are methylated in the genomic DNA. The amount of methylation in a DNA locus may be determined by comparing the quantity of intact DNA or cut DNA to a control value representing the quantity of intact DNA or cut DNA in a similarly-treated DNA sample. The control value may represent a known or predicted number of methylated nucleotides. Alternatively, the control value may represent the quantity of intact or cut DNA from the same locus in another (e.g., normal, non-diseased) cell or a second locus.

By using at least one methylation-sensitive or methylation-dependent restriction enzyme under conditions that allow for at least some copies of potential restriction enzyme cleavage sites in the locus to remain uncleaved and subsequently quantifying the remaining intact copies and comparing the quantity to a control, average methylation density of a locus may be determined. If the methylation-sensitive restriction enzyme is contacted with copies of a DNA locus under conditions that allow for at least some copies of potential restriction enzyme cleavage sites in the locus to remain uncleaved, then the remaining intact DNA will be directly proportional to the methylation density, and thus may be compared to a control to determine the relative methylation density of the locus in the sample. Similarly, if a methylation-dependent restriction enzyme is contacted with copies of a DNA locus under conditions that allow for at least some copies of potential restriction enzyme cleavage sites in the locus to remain uncleaved, then the remaining intact DNA will be inversely proportional to the methylation density, and thus may be compared to a control to determine the relative methylation density of the locus in the sample.

Kits for the above methods may include, e.g., one or more of methylation-dependent restriction enzymes, methylation-sensitive restriction enzymes, amplification (e.g., PCR) reagents, probes and/or primers.

Quantitative amplification methods (e.g., quantitative PCR or quantitative linear amplification) may be used to quantify the amount of intact DNA within a locus flanked by amplification primers following restriction digestion. Methods of quantitative amplification are disclosed in, e.g., U.S. Pat. Nos. 6,180,349; 6,033,854; and 5,972,602, as well as in, e.g., Gibson et al., Genome Research 6:995-1001 (1996); DeGraves, et al., Biotechniques 34(1):106-10, 112-5 (2003); Deiman B, et al., Mol. Biotechnol. 20(2):163-79 (2002).

Bisulfite treatment allows for the specific reaction of bisulfite with cytosine, which, upon subsequent alkaline hydrolysis, is converted to uracil, whereas 5-methylcytosine remains unmodified under these conditions (Shapiro et al, (1970) Nature 227: 1047) is currently the most frequently used method for analyzing DNA for 5-methylcytosine. Uracil corresponds to thymine in its base pairing behavior, that is it hybridizes to adenine; whereas 5-methylcytosine does not change its chemical properties under this treatment and therefore still has the base pairing behavior of a cytosine, that is hybridizing with guanine. Consequently, the original DNA is converted in such a manner that 5-methylcytosine, which originally could not be distinguished from cytosine by its hybridization behavior, may now be detected as the only remaining cytosine using “normal” molecular biological techniques, for example, amplification and hybridization or sequencing. All of these techniques are based on base pairing, which may now be fully exploited. Comparing the sequences of the DNA with and without bisulfite treatment allows an easy identification of those cytosines that have been unmethylated.

An overview of the further known methods of detecting 5-methylcytosine may be gathered from the following review article: Fraga F M, Esteller M, Biotechniques 2002 September; 33(3):632, 634, 636-49.

Several protocols are known in the art. However, all of the described protocols, comprise of the following steps: the genomic DNA is isolated, denatured, converted several hours by a concentrated bisulfite solution and finally desulfonated and desalted (e.g.: Frommer et al.: A genomic sequencing protocol that yields a positive display of 5-methylcytosine residues in individual DNA strands. Proc Natl Acad Sci USA. 1992 Mar. 1; 89(5):1827-31).

The bisulfite-mediated conversion of the genomic sequences into “bisulfite sequences” may take place in any standard, art-recognized format. This includes, but is not limited to modification within agarose gel or in denaturing solvents. The agarose bead method incorporates the DNA to be investigated in an agarose matrix, through which diffusion and renaturation of the DNA is prevented (bisulfite reacts only on single-stranded DNA) and all precipitation and purification steps are replaced by rapid dialysis (Olek A, et al. A modified and improved method for bisulphite based cytosine methylation analysis, Nucl. Acids Res. 1996, 24, 5064-5066).

In the International Patent Application WO 01/98528 (20040152080) a bisulfite conversion is described in which the DNA sample is incubated with a bisulfite solution of a concentration range between 0.1 mol/l to 6 mol/l in presence of a denaturing reagent and/or solvent and at least one scavenger. In the aforementioned patent application, several suitable denaturing reagents and scavengers are described. The final step is incubation of the solution under alkaline conditions whereby the deaminated nucleic acid is desulfonafed.

In the International Patent Application WO 03/038121 (US 20040115663) a method is disclosed in which the DNA to be analyzed is bound to a solid surface during the bisulfite treatment, Consequently, purification and washing steps are facilitated.

In the International Patent Application WO 04/067545 a method is disclosed in which the DNA sample is denatured by heat and incubated with a bisulfite solution of a concentration range between 3 mol/l to 6.25 mol/l. Thereby the pH value is between 5.0 and 6.0 and the nucleic acid is deaminated. Finally an incubation of the solution under alkaline conditions takes place, whereby the deaminated nucleic acid is desulfonated.

In some embodiments, restriction enzyme digestion of PCR products amplified from bisulfite-converted DNA is used to detect DNA methylation. See, e.g., Sadri & Hornsby, Nuel. Acids Res. 24:5058-5059 (1996); Xiong & Laird, Nucleic Acids Res. 25:2532-2534 (1997).

In some embodiments, a MethyLight assay is used alone or in combination with other methods to detect DNA methylation (see, Ends et al.; Cancer Res. 59:2302-2306 (1999)). Briefly, in the MethyLight process genomic DNA is converted in a sodium bisulfite reaction (the bisulfite process converts unmethylated cytosine residues to uracil). Amplification of a DNA sequence of interest is then performed using PCR primers that hybridize to CpG dinucleotides. By using primers that hybridize only to sequences resulting from bisulfite conversion of unmethylated DNA, (or alternatively to methylated sequences that are not converted) amplification may indicate methylation status of sequences where the primers hybridize. Similarly, the amplification product may be detected with a probe that specifically binds to a sequence resulting from bisulfite treatment of a unmethylated (or methylated) DNA. If desired, both primers and probes may be used to detect methylation status. Thus, kits for use with MethyLight may include sodium bisulfite as well as primers or detectably-labeled probes (including but not limited to Taqman or molecular beacon probes) that distinguish between methylated and unmethylated DNA that have been treated with bisulfite. Other kit components may include, e.g., reagents necessary for amplification of DNA including but not limited to, PCR buffers, deoxynucleotides; and a thermostable polymerase.

In some embodiments, a Ms-SNuPE (Methylation-sensitive Single Nucleotide Primer Extension) reaction is used alone or in combination with other methods to detect DNA methylation (see, Gonzalgo & Jones, Nucleic Acids Res. 25:2529-2531 (1997)). The Ms-SNuPE technique is a quantitative method for assessing methylation differences at specific CpG sites based on bisulfite treatment of DNA, followed by single-nucleotide primer extension (Gonzalgo & Jones, supra). Briefly, genomic DNA is reacted with sodium bisulfite to convert unmethylated cytosine to uracil while leaving 5-methylcytosine unchanged. Amplification of the desired target sequence is then performed using PCR primers specific for bisulfite-converted DNA, and the resulting product is isolated and used as a template for methylation analysis at the CpG site(s) of interest.

Typical reagents (e.g., as might be found in a typical Ms-SNuPE-based kit) for Ms-SNuPE analysis may include, but are not limited to: PCR primers for specific gene (or methylation-altered DNA sequence or CpG island); optimized PCR buffers and deoxynucleotides; gel extraction kit; positive control primers; Ms-SNIPE primers for a specific gene; reaction buffer (for the Ms-SNuPE reaction); and detectably-labeled nucleotides. Additionally, bisulfite conversion reagents may include: DNA denaturation buffer; sulfonation buffer; DNA recovery regents or kit (e.g., precipitation, ultrafiltration, affinity column); desulfonation buffer; and DNA recovery components.

In some embodiments, a methylation-specific PCR (“MSP”) reaction is used alone or in combination with other methods to detect DNA methylation. An MSP assay entails initial modification of DNA by sodium bisulfite, converting all unmethylated, but not methylated, cytosines to uracil, and subsequent amplification with primers specific for methylated versus unmethylated DNA. See, Herman et al., Proc. Natl. Acad. Sci, USA 93:9821-9826, (1996); U.S. Pat. No. 5,786,146.

Additional methylation detection methods include, but are not limited to, methylated CpG island amplification (see, Toyota et al., Cancer Res. 59:2307-12 (1999)) and those described in, e.g., U.S. Patent Publication 2005/0069879; Rein et al. Nucleic Acids Res. 26 (10): 2255-64 (1998); Olek, et al. Nat. Genet. 17(3): 275-6 (1997); and PCT Publication No. WO 00/70090.

C. Creation of Long Heptiype Distributions

The invention comprises a method for identifying, cataloguing and interpreting genome-wide DNA methylation patterns of all human genes in all major tissues. Preferably, the method relates to the identification of cytosines that are differentially methylated in different sample types, for example, in different tissues, organs or cell types. The methylation sequences are aligned with respect to the methylated cytosine information. The alignment of the methylated sequences is referred herein as a hepitype.

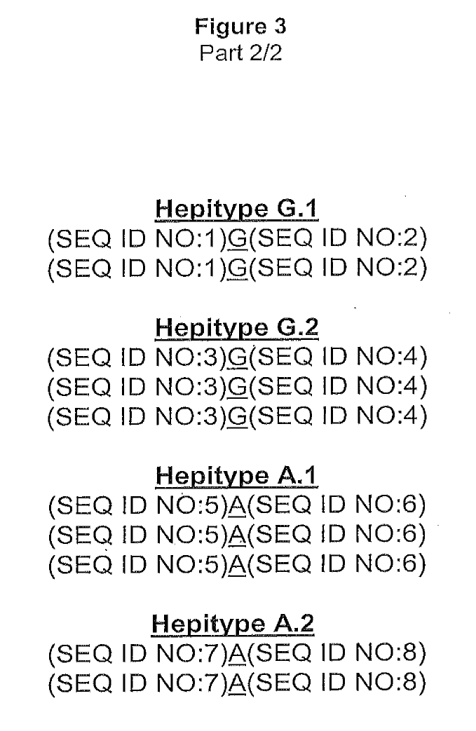

As discusses more fully elsewhere herein, hepitype distributions may be created by way of aligning multiple DNA methylation sequences. For example, DNA sequences generated using sodium bisulfite treatment are aligned with respect to cytosines “c” that are resistant to bisulfite conversion (interpreted as methylated bases). FIG. 3 depicts an example of the assembly of four different hepitypes, belonging to two different SNP haplotypes, by alignment of 10 strings generated by bisulfite DNA sequencing. The alignment makes use of 2 “Bits” of information corresponding to unmethylated (represented by the number 0) or methylated cytosines (represented by the number 1). Long hepitypes are constructed by continuing this alignment process, preferably until the hepitypes are as long as the underlyling haplotype block. That is, long hepitypes are built by continuing the methylated sequence alignment process shown in FIG. 3, and extending the alignments to build larger and larger scaffolds, as is done in genome assembly. The assembly of long hepitypes are based on the following assumptions: (1) there may exist 2 or more LHDs in the sequence alignment; and (2) a joint probabilistic structure.

Ideally, hepitype distributions are constructed to be “longer” and “denser” or “deeper” by using a larger number of bisulfite DNA sequences, so that the probabilistic components of each hepitype distribution may be calculated with increased precision. Hepitypes may change over time, in the context of lineage development, environmental exposures, disease, and drift (methylation maintenance errors). A non-limiting useful mathematical framework for describing LHDs is provided by generalized hidden Markov models (gHMMs, also called hidden semi-Markov models).

In some instances, LHD analysis is not performed using simple averaging. Rather, methylation levels corresponding to LHD are calculated as distributions. In some instances, the distributions are calculated using markov chain statistics.

Hepitypes may change over time, in the context of lineage development, environmental exposures, disease, and drift (methylation maintenance errors). A non-limiting useful mathematical framework for describing LHDs is provided by generalized hidden Markov models (gHMMs, also called hidden semi-Markov models).

Markov models are based on a finite memory assumption, i.e., that each symbol depends only on its k formers, where k is fixed. The simplest model is first-order Markov model, which assume that each symbol at time t depends only on the symbol at time t−1: P(xᵢ=W(i)|x₁=W(1), x₂=W(2), . . . , xᵢ₋₁=W(i−1))=P(xᵢ=W(i)|xᵢ₋₁=W(i−1)), where state i at time t is denoted by Wᵢ(t).

In order to calculate the probability that the model generates a particular sequence, the successive probabilities should simply be multiplied.

Markov models of higher order simply extend the size of the memory. The suggested methods of the present disclosure may be viewed as a varying-order Markov model, since the order of the memory doesn't have to be fixed as explained latter.

In general, Markov Models assume that the states are accessible. In many cases, however, the perceiver does not have access to the states. Consequently, Markov Model should be augmented to Hidden Markov Model, which is a Markov model with invisible states. Hidden Markov model (HMM) is a Markov chain in which the states are not directly observable but instead the output of the current state is observable. The output symbol for each state is randomly chosen from a finite output alphabet according to some probability distribution.

A gHMM generalizes the HMM as follows: in a gHMM, the output of a state may not be a single symbol. Instead, the output may be a string of finite length. For a particular current state, the length of the waiting time in the current state as well as the output string itself might be randomly chosen according to some probability distribution. The probability distribution need not be the same for all states. For example, one state might use a weight matrix model for generating the output string, while another might use a HMM. Without limiting the invention in any way, typically a gHMM is described by a set of four parameters: i) A finite set Q of states; ii) Initial state probability distribution πq; iii) Transition probabilities T_{i,j} for i,jεQ; iv) The waiting time length distribution f of the states (f_{q} is the length distribution for state q); v) Probabilistic models for each of the states, according to which, output strings are generated upon visiting a state.

A simple single-distribution LHD (for example, one derived from a pure population of haploid chromatids, as in the Y chromosome of sperm) comprises a long DNA sequence string where cytosines are methylated (1) or unmethylated (0), and where the state of the 1's and 0's is based on ONE SET of hidden Markov model (HMM) Transition probabilities. The HMM may be constructed using a “third order” HMM, or a “fourth order” HMM, or more preferably a “fifth order” HMM, or even more preferably a “sixth order” HMM, where the state of the six preceding methylated or unmethylated cytosines is used to calculate the probable state of the next cytosine in the sequence.

A two-distribution LHD comprises a long DNA sequence string where cytosines are methylated (1) or unmethylated (0), and where the state of the 1's and 0's is based on TWO different sets of HMM Transition probabilities, representative of TWO different states of chromatin. The TWO different HMMs may be constructed using a “third order” HMM, or a “fourth order” HMM, or more preferably a “fifth order” HMM, or even more preferably a “sixth order” HMM, where the state of the six preceding methylated or unmethylated cytosines is used to calculate the probable state of the next cytosine in the sequence.

A three-distribution LHD comprises a long DNA sequence string where cytosines are methylated (1) or unmethylated (0), and where the state of the 1's and 0's is based on THREE different sets of HMM Transition probabilities, representative of THREE different states of chromatin. The THREE different HMMs may be constructed using a “third-order” HMM, or a “fourth order” HMM, or more preferably a “fifth order” HMM, or even more preferably a “sixth order” HMM, where the state of the six preceding methylated or unmethylated cytosines is used to calculate the probable state of the next cytosine in the sequence.

One shortcoming of the HMM statistical framework is the limited representational power of the latent variables. A more flexible statistical framework than that provided by the HMM is the Infinite Factorial Hidden Markov Model (IFHMM) described by VanGael, The, and Ghahramani (The Infinite Factorial Hidden Markov Model, in Neural Information Processing Systems Foundation, 2008). The IFHMM is a statistic describing a potentially infinite number of binary Markov chains, and has the capability to allow temporal dependencies in the hidden variables. The capability to describe an infinite number of Markov chains, and to represent temporal dependencies may be of utility for the representation of DNA methylation time course data in biological experiments in which new cell lineages are evolving, and therefore DNA methylation marks are changing as governed by relationships of cell lineage and lineage differentiation and branching, evolving over time. Thus, the IFHMM representation of Long Hepitype Distributions (LHDs) is preferred when large amounts of time course DNA methylation sequence data are available that are representative of complex tissues or complex lineages.

Accordingly, the present invention relates to LHDs, which are information-rich structures that may be constructed using existing string alignment tools, making use of DNA methylation information obtained by a multiplicity of DNA sequencing reads. Without wishing to be bound by any particular theory, it is believed that a skilled artisan may incorporate the correlated variational structure of hepitype information into any convenient statistical framework, such as a gHMM or a IFHMM. Thus, the inventive step is the realization that variation in DNA methylation, combined with long DNA sequence reads, enable the building of novel, long hepitype assemblies. According to the present invention, methylation analysis allows for the determination of the cell- or tissue-type of DNA origin, allowing initiation of further examination for determination of the right treatment in an accurate and efficient manner; particularly crucial where the disease is cancer.

According to the present invention, bisulfite sequencing or otherwise methylated sequences provide sufficient robustness for high throughput applications. The quantification and standardization of the data is provided by one or more algorithms or a software program that allows for constructing LHD structures based on alignment of the DNA methylated sequences.

The information provided by LHD structures provides a novel resource for the understanding of fundamental biological processes such as gene regulation, imprinting of genes, development, genome stability, disease susceptibility and the interplay of genetics and environment. Moreover, such knowledge may be used to assess if and how methylation patterns respond to environmental influences, such as nutrition, or smoking, etc. Moreover, the information provided from LHD structures enables correlations of at least DNA-methylation patterns with parameters such as tumorigenesis, progression and metastasis, stem cells and differentiation, proliferation and cell cycle, diseases and disorders, and metabolism to be generated.

In some instances, LHDs comprise information relevant to: 1) establishment and maintenance of lineages; 2) establishment of “chromatin states” that may relate to transcriptional activity; and 3) shifts (loss of stability) due to aging, stress, inflammation, or environmental insults. These three types of information, lineage establishment, specific transcriptional states, as well as loss of stability of a lineage specifier or a transcriptional state specifier represent an information hierarchy that may constitute a powerful descriptor of cellular phenotype, especially if when heterogenous phenotypes are present.

LHD is distinguishable from local (short) DNA methylation information because, unlike the latter, LHDs contain genetic linkage information descriptive of an entire structural locus, and encompasses the information hierarchies of lineage establishment, specific transcriptional states, as well as loss of stability of a lineage specifier or a transcriptional state specifier. A local (short) DNA methylation pattern will not encapsulate as much information because it is unlinked from neighboring information-containing DNA sequence elements.

The recent discovery of 5-hydroxymethylcytosine in the DNA of neurons (Kriaucionis S, Heintz N., The Nuclear DNA Base 5-Hydroxymethylcytosine Is Present in Purkinje Neurons and the Brain. Science, April 2009) implies that for a large number of cytosines in the genome there will be three alternative states, unmethylated cytosine (represented as 0), 5-methyl cytosine (represented asl) and 5-hydroxymethylcytosine (represented as The mathematical handling of three possible states for a methylation variable is readily accommodated through the use of a ternary data representation (0,1,−1) in the HMM, gHMM, and IFHMM statistics. The presence of three alternative states of cytosine (0,1,−1) in neurons implies a large increase in the information content of DNA methylation strings, and it is possible that neurons make use of this epigenetic information to help carry out cognitive tasks. At this point, we lack tools for generating DNA sequences where 5-methylcytosine would be distinguishable from 5-hydroxymethylcytosine. As sequencing tools become available in the future, capable of reporting these chemical differences in a DNA sequence, the mathematical representation of LHD data structures and statistical analysis may readily be extended to accommodate this new information.

D. Creation of a Holocomplement

The methods of the invention includes development of algorithms and software to manipulate a multiplicity of LHDs, as would be generated by DNA methylation analysis of a large portion of the human genome. When a large set of LHDs is available, the analysis of statistical correlations among LHDs, as well as the analysis of interactions between genes associated with each LHD, may lead to important insights about the regulatory states of individual subsets of cells in tissue. For example, each subset of cells harbors a holocomplement of hepytypes. A holocomplement is the collection of all the co-resident hepitypes (representing all haplotype blocks) in a diploid chromosome complement, within the nucleus of a single cell, or in a homogeneous population of cells closely related by lineage. The holocomplement of each cell gets scrambled during DNA extraction of tissue. Using the methods discussed elsewhere herein, reconstruction of each holocomplement by observing correlations among fractional states in the tables of genome-wide hepitype frequencies may be accomplished.

The invention also includes development of algorithms and tools for analysis of large dataset from which different holocomplement components. This set of tools is called Holocomplement Matrix Analysis (LHD-MA). According to the methods of the invention, individual holocomplement may be constructed from sequence data and a multiplicity of LHD data structures obtained from a mixture of cells, where different populations contribute different holocomplements, by deducing correlations among fractional states in the tables of genome-wide hepitype frequencies, using maximum parsimony approaches. Knowledge of regulatory network interactions is useful to facilitate this process of “deconvolution” of holocomplements. The analysis may additionally include phylogenetic tree analysis of methylation string bits from DNA sequences from different loci.

According to the methods of this invention, individual holocomplements may be constructed from sequence data and a multiplicity of LHD data structures obtained from a mixture of cells where different cell populations contribute to different holocomplements. In some instances, individual holocomplements may be constructed by deducing correlations among fractional states in the tables of genome-wide hepitype frequencies using maximum parsimony approaches. Also useful in the construction of homocomplements is knowledge of regulatory network interactions to facilitate the process of “deconvolution” of holocomplements. The analysis may additionally include phylogenetic tree analysis of methylation string bits from DNA sequences from different loci.

In one embodiment of the invention, the biological sample is perturbed to generate a new data set where the different cell populations respond differentially to the perturbation, thus differentially altering the individual holocomplements, and generating new informative correlations of the data.

In one embodiment, the invention includes a method for reconstructing the most likely population structure of different cells in a tissue sample, by means of LHD holocomplement Matrix Analysis (LHD-MA), a method for discovery of correlated data structures observed among a multiplicity of long hepitype distribution data obtained from one or more biological samples.

In another embodiment, the invention includes a method for deducing cell lineage structures from the methylation patterns present in different distributions of DNA methylation bits present in each of the cell sub-population components emerging from LHD-MA.

In yet another embodiment, the invention includes a method for deducing environmental exposures to agents that affect DNA methylation from the methylation patterns present in different DNA methylation bits present in each of the cell sub-population components emerging from LHD-MA.

In one embodiment, the invention includes a method for deducing relative genome “aging” or “regulatory deterioration” or “genomic insability” from the methylation patterns present in different DNA methylation bits present in each of the cell sub-population components emerging from LHD-MA.

In another embodiment, the invention includes a method for deducing differential drug responses from the methylation patterns present in different DNA methylation bits present in each of the cell sub-population components emerging from LHD-MA.

### Application

The present invention provides a method for diagnosing a condition or disease characterized by specific methylation levels or methylation states of one or more methylation variable genomic DNA positions in a disease-associated cell or tissue or in a sample derived from a bodily fluid, comprising: obtaining a test cell, tissue sample or bodily fluid sample comprising genomic DNA having one or more methylation variable positions in one or more regions thereof; determining the methylation state or quantified methylation level at the one or more methylation variable positions; and comparing the methylation state or level to that of a genome wide methylation map, the map comprising methylation level values for at least one of corresponding normal, or diseased cells or tissue, whereby a diagnosis of a condition or disease is, at least in part afforded.

In one embodiment, the invention provides a means to address the problem of generating DNA methylation descriptors for samples that may contain heterogeneity in DNA methylation. In some instances, LI-ID provides a type of epigenetic analysis useful for addressing heterogeneity in a tissue. In other instances, MD is useful for addressing heterogeneity that is inherent in having two different autosomes within each cell. This is because contrary to prior art methods, LHD analysis is not performed using simple averaging. Moreover, contrary to prior art methods, LHD analysis is associate with much longer distances than 3 kb. Thus, methylation patterns in LHD are much longer and contain a much larger amount of information, including single chromatid linkage information and cell type heterogeneity information.

In one embodiment, LHD includes analysis of methylation states over regions that greatly exceed 3 kilobases. The regions comprising an LHD are typically 10 kb to 500 kb in length, and more typically 20 kb to 500 kb in length. For example, an LHD region of 120 kb typically contain more than one methylation state. As a minimum most samples will by definition contain at least two statistical distributions of CpG strings, one for each chromosome in each pair of autosomes. In the special case of the X chromosome and the Y chromosome in a biological sample from a male individual, and assuming the sample comprises a pure cell type (rather unlikely) there could possibly exist a single DNA methylation statistical distribution. But this is the exception rather than the rule.

Most biological samples used for research or clinical diagnostic applications contain more than two DNA methylation distributions, since there is heterogeneity among different cells in a biological sample. Most biological samples, even those derived from a single tissue, may contain several cell types. For example, a breast biopsy will contain epithelial cells and stromal cells. A liver sample may contain hepatocytes and stellate cells, as well as cells from peripheral blood. Samples containing two types of cells would contain a minimum of four DNA methylaiton distributions, since there are two pairs of autosomes. In most cases, for a heterogeneous mixture comprising different cell types the number of DNA methylation statistical distributions are larger than four.

The present invention relating to LHD information is also useful in identifying causes of certain diseases with strong epigenetic components. For example, the invention may be used in toxicology studies, where the subtle effects of drugs in tissues may be readily be observed by examination of LHDs, even in situations where the number of cells suffering from toxicity responses comprise a very small fraction of the cells in tissue. The LHD information may also reveal accurately those subtle changes occurring in for example a special sub-compartment of the heart tissue. In some instances, the LHD information may be used to measure toxicity of therapeutic drugs in tissues of experimental animals, and may deliver quantitative metrics.

The method of the invention relating to the LHD information may also be used in tissue engineering and regenerative medicine, including stem cell based therapies, where clinicians may accurately trace different cell lineages in humans, without the use of artificial genetically engineered constructs, as are currently used in animal studies.

The LHD information may also be used in genetic association studies, to discover new gene loci implicated in human diseases. The invention is useful for unraveling the mechanism of complex (multifactorial) diseases, for example those with strong epigenetic components.

The LHD information may be used in animal breeding and animal cloning, to assess the molecular phenotypes of crosses, as well as the molecular phenotypes of clones. The use of LHD information increases the discriminatory power for assessing whether the different tissues of cloned animals are normal or abnormal from the epigenetic standpoint.

The LHD information may be used to measure the aging of different tissues, and may deliver quantitative metrics of the “regulatory integrity” or “deviation from normalcy” of any tissue from which DNA may be obtained.

The LHD information may be used to measure immune disregulation though analysis of cell populations, and may deliver quantitative metrics of the regulatory integrity of the immune system.

The LHD information may be used to measure the environmental impact of chemical compounds or radioisotopes.

The LHD information may be used as metastable, tissue-specific quantitative trait loci in genetic association studies.

The LHD information may be used as descriptors or metrics of environmental or pharmacological exposures.

The LHD information may be used as descriptors or metrics of aging in a specific tissue type.

The LHD information may be used as descriptors or metrics of neurodegeneration.

The LHD information may be used as descriptors or metrics of immune disregulation.

The LHD information may be used as descriptors or metrics of drug responses.

Throughout this disclosure, various aspects of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

It is contemplated that any embodiment discussed in this specification may be implemented with respect to any method or composition of the invention, and vice versa. Furthermore, compositions of the invention may be used to achieve methods of the invention.

Other objects, features and advantages of the present invention will become apparent from the detailed description herein. It should be understood, however, that the detailed description and the specific examples, while indicating specific embodiments of the invention, are given by way of illustration only, since various changes and modifications within the spirit and scope of the invention will become apparent to those skilled in the art from this detailed description.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

### Example 1

### Hepitypes within a SNP Locus

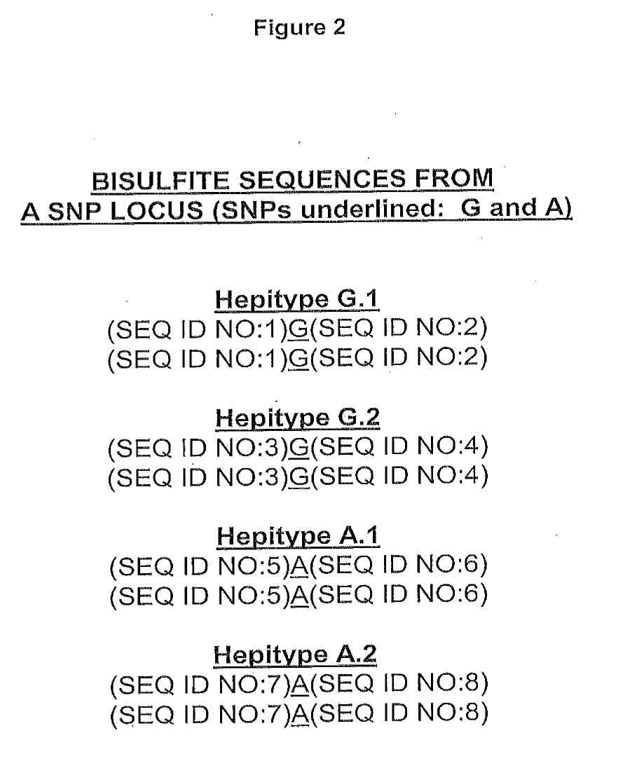

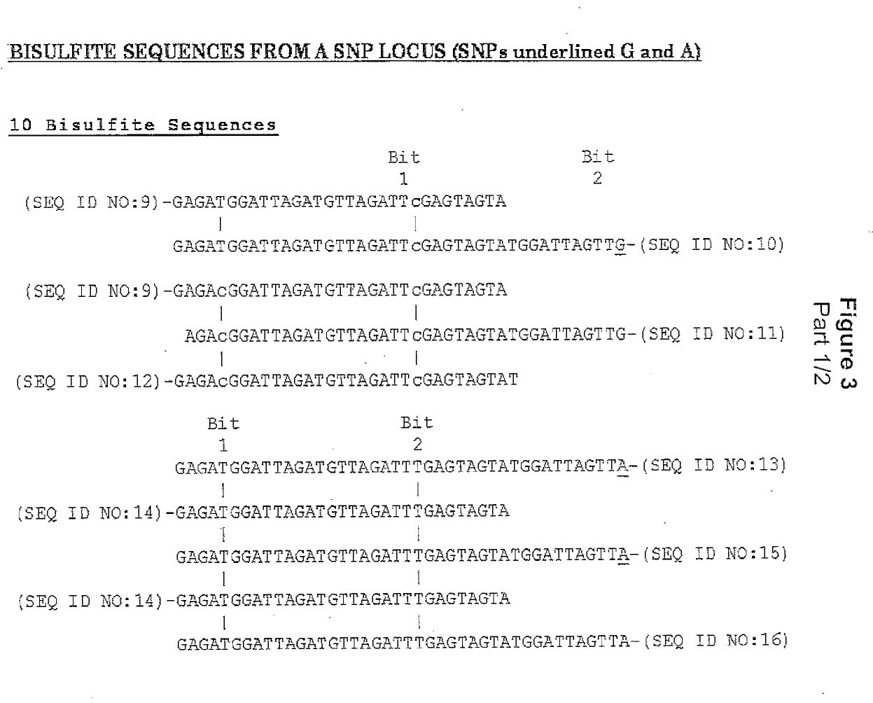

Murrell et al. (2005) proposed the term hepitype to define subtle, reproducible patterns of epigenetic variation within a single haplotype, where alternative, reproducible modifications of the DNA sequence occur by virtue of the presence or absence of 5-methyl-cytosine modifications. Thus, in a sample of “n” sequences comprising “s” dimorphic SNPs and additionally “m” potentially dimorphic cytosines, there could be as many as 2^{(s+m)} different hepitypes, but in fact the number of observed hepitypes may be much smaller. For any unique SNP haplotype block, the variation in the methylation status of each cytosine base position may be treated as an on/off binary character, and thus one may compute a hamming distance between any two hepitypes belonging to the same haplotype block. One would expect that hepitypes belonging to a unique haplotype block would show variations that, based on Euclidean distance, are less distant from each other, as compared to each of the individual members of a different set of hepitypes associated with another haplotype block, at the same locus. FIG. 2, shows bisulfite DNA sequences harboring a SNP locus (G or A), and each may be seen to be associated with two distinct, but closely related hepitypes.

Statistical formalisms to describe hepitypes may be developed based on the disclosure presented herein. While the acquisition of standard DNA sequence data is now a routine procedure, this is not the case for data that contains cytosine methylation information due to technical challenges. The method of choice for obtaining DNA sequences that contain cytosine methylation information is based on treatment of DNA with sodium bisulfite, which selectively converts cytosine to uracyl, while methylated cytosine remains unchanged. This method works relatively well and is widely used, nonetheless, bisulfite partially degrades DNA, and the average length of DNA sequence that may be easily obtained is of the order of 800 bases or less. In view of the fact that haplotype block size ranges from 5 Kb to 200 Kb, one has to deal with the problem of trying to assemble the hepitypes that belong to any given haplotype block class, while facing the limitations imposed by a DNA sequence read limit of 800-1000 bases.

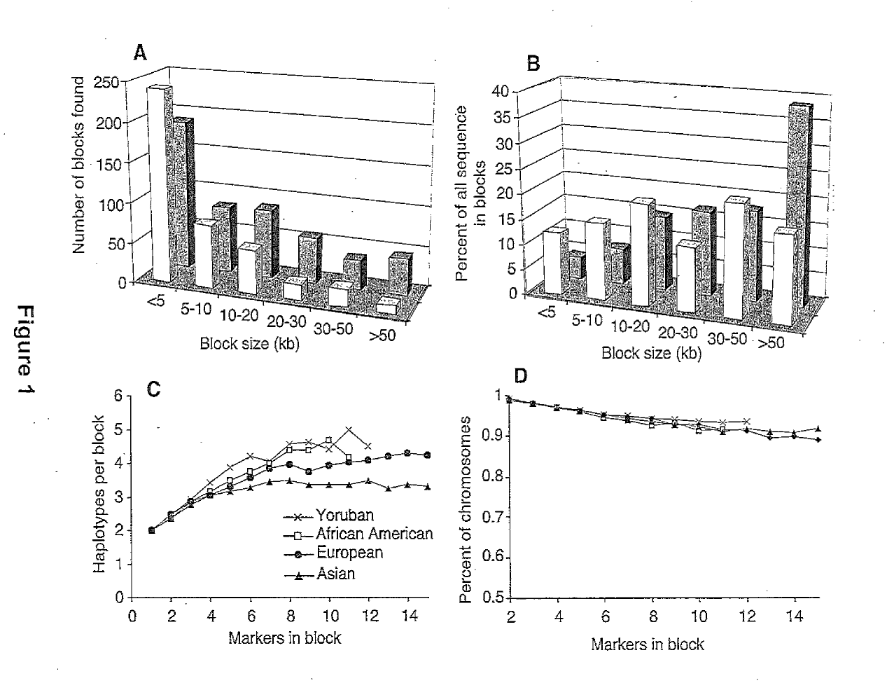

The content of cytosines present in the human genome typically exists as CpG dinucleotides, and thus subject to the possibility of chemical modification by DNA methylation is approximately 26.9 million. Thus, a cytosine subject to methylation occurs, on the average, every 111 bases. However, the distribution of these cytosines is not random, but characteristically shows clustering in sequence domains known as CpG islands, and a sparse distribution elsewhere. As discussed elsewhere herein, this distribution has important implications for the generation of LHDs from scaffolds of available DNA sequence reads, obtained by bisulfite sequencing. The typical observed variation of cytosine methylation, based on published studies that examine sequence windows that typically contain 10 to 25 potentially methylatable cytosine residues, is of the order of 5% to 20%, but may be 80% to 95% in those eases where there is an important developmental change at a methylation-regulated locus. In some experiments discussed herein, 10% variation among different DNA strands is used as a reasonably conservative number to evaluate the problem of long hepitype assembly. This variation is much lower than that shown in FIG. 1. When variation is 10%, and a sequence read of 2000 bases contains 15 methylatable cytosines, many experimental sequence reads are likely to differ by one or two methylated bases. If the sequence read length is extended to 4000 bases, and there are 30 methylatable cytosines in the interval, many experimental sequence reads would differ by three methylated bases. These simple calculations suggest that as sequence reads begin to approach 4000 bases or more, there may in some cases be sufficient information in the sequence of methylated or unmethylated bases to distinguish strands as belonging to different hepitypes. Until very recently, the longest sequence reads available at this time using commercial instrumentation are of the order of 1000 bases.

Recent developments in DNA sequencing technology are poised to dramatically change the landscape of commercial instrumentation that will become widely available to any laboratory, resulting in higher throughput and dramaticallly lower costs. Some of the new technologies will bring important changes in the maximum length of sequence reads. For example, Pacific Biosciences, at Menlo Park, Calif. is developing a next-generation DNA sequencing technology based on optical waveguides that is capable of yielding read lengths of the order of 4,000 to 12,000 bases, limited mostly by DNA shear during handling. Thus, the present invention is predicated on analytical capabilities that may be developed as a new generation of long-read sequencing technologies comes to the market. A recent publication (Flusberg B A, Webster D R, Lee J H, Travers K J, Olivares E C, Clark T A, Korlach J, Turner S W. “Direct detection of DNA methylation during single-molecule, real-time sequencing.” Nat Methods. 2010 May 9. [Epub ahead of print]) demonstrates that it is possible to obtain DNA methylation information using single-molecule, real-time (SMRT) sequencing. As indicated earlier, this technology, commercialized by Pacific Biosciences, Menlo Park, Calif. potentially enables DNA methylation sequencing reads that may be as long as 12,000 bases after methods optimization. Notably, the publication by FLusberg et al. also shows that it is possible to identify the position in a sequence of N⁶-methyladenine and 5-hydroxymethylcytosine, in addition to 5-methylcytosine. Thus, three different types of chemical modifications of DNA, based on DNA methylation, can be detected in a DNA sequence. The modification of DNA by substitution of cytosine by 5-hydroxymethylcytosine is of particular interest in the study of the nervous system (Kriaucionis S, Heintz N. “The nuclear DNA base 5-hydroxymethylcytosine is present in Purkinje neurons and the brain.” Science. 2009 May 15; 324(5929):929-30. Epub 2009 Apr. 16).

A custom computer program was used to analyze the human genome, by examining DNA windows of length “w” (corresponding to the sequencing read length) and for each window calculating the count “c” of CpG dinucleotides. A user adjustable threshold value was chosen to represent the minimum allowable count of “c” for any given window. This minimum is set arbitrarily, guided by the following considerations: if the expected variation in DNA methylation is approximately 10%, then a window containing a count of c=40 will in general differ from the corresponding DNA string at the same window, but in another cell type, by a count of 4 cytosine residues that may have flipped the status of the methylation “bit”. Thus, a minimum value of c=40 corresponds to a situation where the variational information is likely to be approximately 4 bits for most windows in the DNA strand. The reason for choosing a minimum of 4 bits of variational information is that the occurrence of these changes may provide sufficient information for distinguishing among 2*2*2*2=16, or as many as sixteen different DNA sequences, corresponding to different hypothetical hepitype configurations.

The first panel of Table I (A) shows the results of running the program to calculate, for w=5000 and c=40, the “failure rate”, that is the percentage of windows that contain less than 40 CpG residues. The second panel (B) shows a similar analysis where the value of the sequence read length has been doubled to w=10000, while maintaining c=40. The tables show the “failure rate” as a percentage for each chromosome, as well as the average failure rate for all chromosomes.

### Table I.

Shows the percentage of failure to yield 40 bits of epigenetic information, for windows of 5000 (A) or 10000 (B) bases across the human genome

TABLE IA
w = 5000

| fall windows | all windows | failure rate | |
|---|---|---|---|
| (under 40) | 5000 | (percent) | chromosome |
| 20322 | 42916 | 47.4% | 1 |
| 10780 | 25393 | 42.5% | 10 |
| 13091 | 25243 | 51.9% | 11 |
| 12574 | 25074 | 50.1% | 12 |
| 11085 | 18352 | 60.4% | 13 |
| 8551 | 17000 | 50.3% | 14 |
| 5785 | 15711 | 36.8% | 15 |
| 3840 | 15283 | 25.1% | 16 |
| 3081 | 15079 | 20.4% | 17 |
| 7681 | 14378 | 53.4% | 18 |
| 1345 | 10815 | 12.4% | 19 |
| 24851 | 45713 | 54.4% | 2 |
| 3771 | 11514 | 32.8% | 20 |
| 3030 | 6590 | 46.0% | 21 |
| 816 | 6755 | 12.1% | 22 |
| 22521 | 37401 | 60.2% | 3 |
| 24200 | 35884 | 67.4% | 4 |
| 20738 | 34151 | 60.7% | 5 |
| 18063 | 32171 | 56.1% | 6 |
| 15066 | 29808 | 50.5% | 7 |
| 15028 | 27446 | 54.8% | 8 |
| 11048 | 22692 | 48.7% | 9 |
| 18195 | 28889 | 63.0% | X |
| 3242 | 4767 | 68.0% | Y |
| 278704 | 549025 | 50.8% | all |

TABLE IB
w = 10000

| fail windows | all windows | failure rate | |
|---|---|---|---|
| (under 40) | 10000 | (percent) | chromosome |
| 792 | 21805 | 3.6% | 1 |
| 295 | 12895 | 2.3% | 10 |
| 524 | 12835 | 4.1% | 11 |
| 552 | 12749 | 4.3% | 12 |
| 466 | 9344 | 5.0% | 13 |
| 332 | 8640 | 3.8% | 14 |
| 99 | 7973 | 1.2% | 15 |
| 50 | 7737 | 0.6% | 16 |
| 46 | 7625 | 0.6% | 17 |
| 225 | 7310 | 3.1% | 18 |
| 17 | 5458 | 0.3% | 19 |
| 848 | 23252 | 3.6% | 2 |
| 56 | 5832 | 1.0% | 20 |
| 80 | 3346 | 2.4% | 21 |
| 7 | 3409 | 0.2% | 22 |
| 877 | 19045 | 4.6% | 3 |
| 1214 | 18289 | 6.6% | 4 |
| 842 | 17380 | 4.8% | 5 |
| 874 | 16367 | 5.3% | 6 |
| 512 | 15146 | 3.4% | 7 |
| 557 | 13958 | 4.0% | 8 |
| 325 | 11526 | 2.8% | 9 |
| 934 | 14711 | 6.3% | X |
| 228 | 2430 | 9.4% | Y |
| 10752 | 279062 | 3.9% | all |

A striking feature of the data in Table 1 is the sharp reduction (over 10-fold) in the failure rate as the sequence read window is changed from w=5000 to w=10000. Note that when the read length is 10,000 bases, the failure rate is only 0.2% for chromosome 22, and 9.4% for the X chromosome, with the average failure rate being 3.9% among all chromosomes. These calculations suggest that the new very long-read sequencing technologies will make it possible to assemble LHDs for more than 95% of genetically relevant loci in the human genome.

When cells and tissues are exposed to external stimuli, such as stress (infection, inflammation) or environmental toxicants, there is a greater likelihood of epigenetic alterations, and the literature contains many examples that document changes in DNA methylation at multiple loci. When the frequency of DNA methylation alterations involves around 25% of methylatable cytosines, the local density of information “bits” increases, and 18 CpG residues may suffice to generate over 4 bits of variational information. The data in Table II simulates this new situation. The first panel of Table II (A) shows the results of running the computer simulation program to calculate, for w=2500 and c=18, the “failure rate”, that is the percentage of windows that contain less than 18 CpG residues. The second panel (B) shows a similar analysis where the value of the sequence read length has been doubled to w=5000, while maintaining c=18.

### Table II.

Shows the percentage of failure to yield 18 bits of epigenetic information, for windows of 2500 (A) or 5000 (B) bases across the human genome.

TABLE IIA
w = 2500

| fall windows | all windows | failure rate | |
|---|---|---|---|
| (under 18) | 2500 | (percent) | chromosome |
| 31986 | 83212 | 38.4% | 1 |
| 16793 | 49312 | 34.1% | 10 |
| 20841 | 48910 | 42.6% | 11 |
| 19869 | 48587 | 40.9% | 12 |
| 17522 | 35467 | 49.4% | 13 |
| 13438 | 32938 | 40.8% | 14 |
| 8901 | 30564 | 29.1% | 15 |
| 6047 | 29867 | 20.2% | 16 |
| 4901 | 29492 | 16.6% | 17 |
| 11909 | 27828 | 42.8% | 18 |
| 2186 | 21231 | 10.3% | 19 |
| 38684 | 88462 | 43.7% | 2 |
| 5763 | 22434 | 25.7% | 20 |
| 4700 | 12788 | 36.8% | 21 |
| 1304 | 13244 | 9.8% | 22 |
| 35300 | 72305 | 48.8% | 3 |
| 38591 | 69147 | 55.8% | 4 |
| 32764 | 65953 | 49.7% | 5 |
| 28638 | 62189 | 46.0% | 6 |
| 23711 | 57754 | 41.1% | 7 |
| 23963 | 53133 | 44.2% | 8 |
| 17079 | 43995 | 38.8% | 9 |
| 28692 | 55776 | 51.4% | X |
| 5230 | 9199 | 56.9% | Y |
| 438312 | 1063787 | 41.2% | all |

TABLE IIB
w = 5000

| fail windows | all windows | failure rate | |
|---|---|---|---|
| (under 18) | 5000 | (percent) | chromosome |
| 1432 | 42916 | 3.3% | 1 |
| 620 | 25393 | 2.4% | 10 |
| 932 | 25243 | 3.7% | 11 |
| 1014 | 25074 | 4.0% | 12 |
| 895 | 18352 | 4.9% | 13 |
| 590 | 17000 | 3.5% | 14 |
| 232 | 15711 | 1.5% | 15 |
| 134 | 15283 | 0.9% | 16 |
| 119 | 15079 | 0.8% | 17 |
| 454 | 14378 | 3.2% | 18 |
| 65 | 10815 | 0.6% | 19 |
| 1647 | 45713 | 3.6% | 2 |
| 148 | 11514 | 1.3% | 20 |
| 171 | 6590 | 2.6% | 21 |
| 19 | 6755 | 0.3% | 22 |
| 1539 | 37401 | 4.1% | 3 |
| 2154 | 35884 | 6.0% | 4 |
| 1499 | 34151 | 4.4% | 5 |
| 1562 | 32171 | 4.9% | 6 |
| 999 | 29808 | 3.4% | 7 |
| 1072 | 27446 | 3.9% | 8 |
| 677 | 22692 | 3.0% | 9 |
| 1580 | 28889 | 5.5% | X |
| 373 | 4767 | 7.8% | Y |
| 19927 | 549025 | 3.6% | all |

In this new simulation scenario the two tables again show a sharp reduction (over 10-fold) in the failure rate as the sequence read window is increased from w=2500 to w=5000. Note that when the read length is 5,000 bases, the failure rate is only 0.3% for chromosome 22, and 5.5% for the X chromosome, with the average failure rate being 3.6% among all chromosomes. These calculations suggest that when the DNA methylation variational information is high (25%) the task of long hepitype alignment and assembly becomes easier, and therefore the need for extremely long reads is somewhat reduced, from 10,000 (Table I) down to 5,000 (Table II).

### Example 2

### Creation of Hepitype Distributions Using an Alignment of DNA Multiple DNA Methylation Sequences

FIG. 3 shows 10 hypothetical DNA sequences generated using sodium bisulfite. The bases highlighted in yellow are cytosines “e” that resisted bisulfite conversion, and are therefore interpreted as methylated bases. The alignment of these 10 different sequences is performed taking advantage of the methylated cytosine information, indicated as Bit 1 and Bit 2. From the alignment, the most likely sequence configurations may be inferred, corresponding to hepitypes G.1, G.2 (for the first SNP) and A.1, A.2, (for the second SNP). In this example, the average distance between any two hepitypes is 4 bits of information (including the SNP bit), and the average variation (among 10 CpGs) is 43%. Note that the structure of a hepitype is not deterministic (as with haplotype blocks) but probabilistic, as evidenced by individual strand variation in Hepitype G.2 and Hepitype A.1. Without wishing to be bound by any particular theory. It is believed that if more sequence information is available for alignment, these hepitypes may be made longer.

Long hepitypes are constructed by continuing this process, ideally until the hepitypes are as long as the underlyling haplotype block. In other words, long hepitypes are built by continuing the methylated sequence alignment process shown in FIG. 3, and extending the alignments to build larger and larger scaffolds, as is done in genome assembly. The key assumptions are: 1) there may exist 2 or more LHDs in the sequence alignment; 2) each LHD represents a probabilistic structure with correlated variation of several methylated bases.

It is of note that treatment with sodium bisulfite partially degrades DNA, and that the average length of DNA sequences that may be rescued by PCR after bisulfite treatment is of the order of 1000 bases or less. Larijani et al (2005) reported that the enzyme Activation-Induced Deaminase (AID) has a low activity for deamination of methylated cytosine, relative to cytosine. These observations suggests that in the future, it may be possible to engineer enzymes capable of performing selective deamination of unmethylated cytosine, thus replacing sodium bisulfite as the reagent of choice for determination of DNA methylation status by sequencing. An important feature of a cytosine deamination reaction performed enzymatically would be the elimination of DNA degradation. In view of these opportunities for technological improvement, it only seems a matter of time before it becomes routine to obtain DNA methylation information using reads in the range of 4,000 to 10,000 bases.

The next set of experiments relates to modeling approaches applicable to hepitypes. The simple alignment of 10 sequences shown in FIG. 3 was used to build four different “sparse” hepitype distributions. Ideally, hepitype distributions should be made longer and “denser” or “deeper” by using a larger number of bisulfite DNA sequences, so that the probabilistic components of each hepitype distribution may be calculated with increased precision. Hepitypes may change over time, in the context of lineage development, environmental exposures, disease, and drift (methylation maintenance errors). A useful mathematical framework for describing LHDs is provided by generalized hidden Markov models (gHMMs, also called hidden semi-Markov models). Accordingly, the present invention relates to information-rich structures called LHDs that may be constructed using existing string alignment tools, making use of DNA methylation information obtained by a multiplicity of DNA sequencing reads. Without wishing to be bound by any particular theory, it is believed that a skilled artisan may incorporate the correlated variational structure of hepitype information into any convenient statististical framework, such as a gHMM. Thus, the invention is based on the realization that variation in DNA methylation, combined with long DNA sequence reads, enable the building of novel, long hepitype assemblies that had never been contemplated in the prior art.

### Example 3

### Long Hepitype Distributions (LHDs) as Descriptors of Mosaics of Cell Phenotypes

While the phenotype of an individual is easily described for those traits that are a property of an easily visible structure, like the color of hair, or the color of eyes, there exist other phenotypes that are more difficult to describe. For example, the odor sensitivity phenotype is complex, because there is a very large set of odorants that in principle could be tested, and the tissue structures responsible for the response comprise an array of thousands of different cells (neurons) with different odorant response properties. Behavioral phenotypes represent an even more complex example, where multiple subtle phenotypes may be assessed, and for each trait the brain tissue responsible for the phenotype comprises heterogeneous cell types and a myriad of connections among them.

There is considerable evidence suggesting that DNA methylation information may encode information relevant to: 1) establishment and maintenance of lineages; 2) establishment of “chromatin states” that may relate to transcriptional activity; and 3) shifts (loss of stability) due to aging, stress, inflammation, or environmental insults.

The three types of information listed above, lineage establishment, specific transcriptional states, as well as loss of stability of a lineage specifier or a transcriptional state specifier, represent an information hierarchy that may constitute a powerful descriptor of cellular phenotype, especially if when heterogenous phenotypes are present. Interestingly, LHDs may encapsulate all three types of information. Thus a long hepitype encompassing an entire 100 Kb gene locus may contain a subset of flipped bits indicative of lineage membership, while other flipped bits may indicate a silenced state of the locus, and yet another set of bits may reveal a subset of cells where the “normal” methylated, silenced state has given way to a demethylated, partially active state. For any subset of cells that display a different phenotypic state relative to the rest of the tissue, a long hepitype may provide a quantitative metric of tissue mosaicism that may be crucial for understanding a complex disease process.

It should be emphasized that LHD information is distinguishable from local (short) DNA methylation information because, unlike the latter, it contains genetic linkage information descriptive of an entire structural locus, and encompassing the information hierarchies listed above, lineage establishment, specific transcriptional states, as well as loss of stability of a lineage specifier or a transcriptional state specifier. A local (short) DNA methylation pattern will not encapsulate as much information because it is unlinked from neighboring information-containing DNA sequence elements.

The discovery of genetic traits associated with risk of disease may be performed with greater power by using haplotype block information. When plotting Linkage Disequilibrum (LD) across the human genome, the treatment of a block of single SNPs as a single allele, if used correctly, may result in a reduction in noise, and may therefore detection of small association effects. For example, one 84 kb block of 8 SNPs may show just two distinct haplotypes accounting for 95% of the observed chromosome sequences, and these two haplotypes yield association data with lower noise than 8 SNPs individually. LHDs may likewise reduce informational noise in epigenetic association studies. Thus, LHDs may be considered as a framework where epigenetic information may be “aggregated” in a manner that reduces the number of data vectors, but does so without averaging potentially informative differences among individual cells.

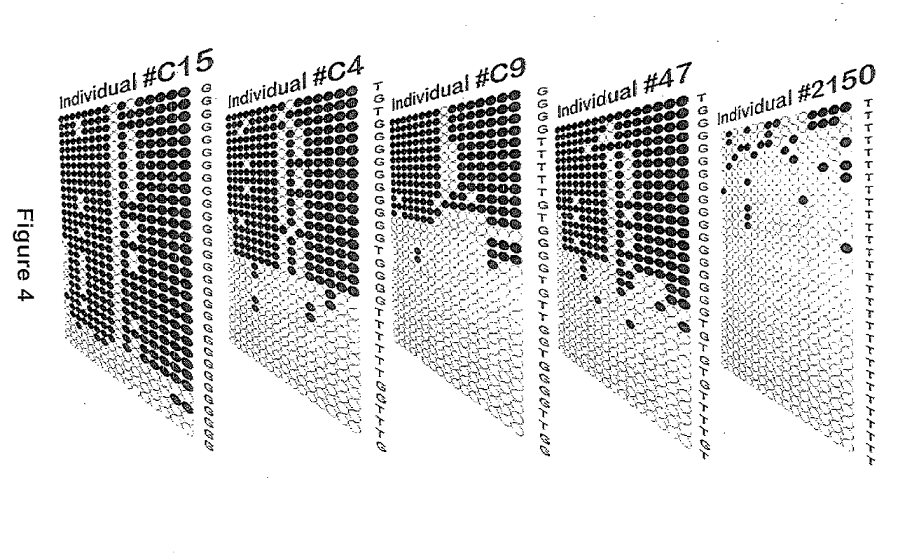

In a recent review article, Mill and Petronis (2007) have pointed out that genetic-epigenetic interactions may be commonplace across the genome, and may be critical for understanding “complex” diseases. Hepitypes that combine both DNA sequence and epigenetic information may thus be better predictors of disease risk than genetic or epigenetic components analysed separately. There is increasing evidence that some DNA alleles and haplotypes tend to be associated with a specific epigenetic profile. For example, the C102T polymorphism in the serotonin 5-HT2A receptor gene (5HT2AR), which has been associated with several psychiatric disorders including depression, was found to be methylated specifically on the C allele (Polesskaya et al, 2006). Additionally, a recent epigenetic study of a CIG single nucleotide polymorphism (SNP) in the CDH13 gene in male germline cells revealed, as shown below in FIG. 4, that C alleles are predominantly unmethylated, while G alleles are predominantly methylated (Flanagan et al., 2006). These short hepitype patterns could be extended, if more data were available, to construct LHDs.

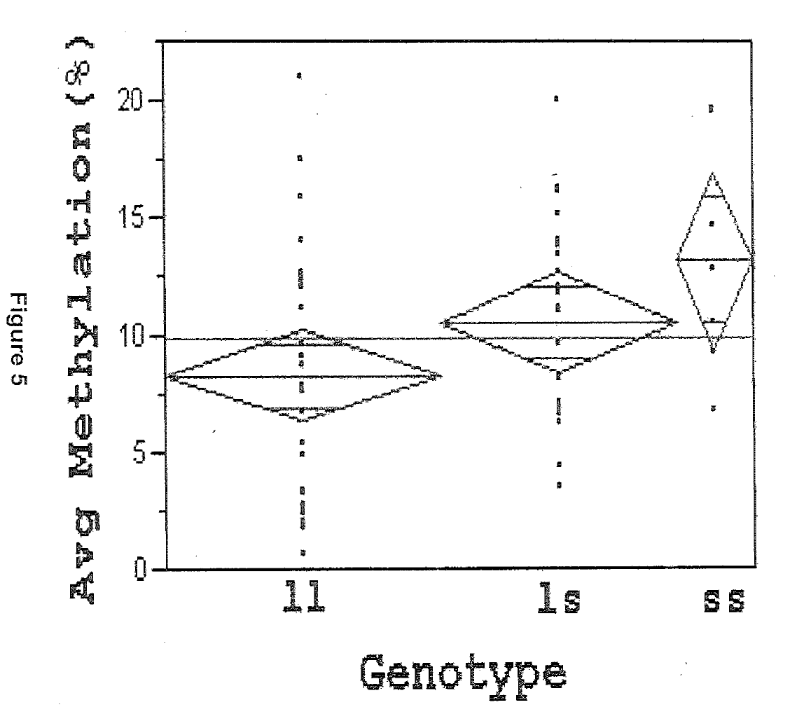

As depicted in FIG. 3, DNA methylation variation may be used to generate sequence alignments that combine epigenetic and SNP information, thereby building a hepitype distribution. As a non-limiting example, the utility of building hepitype distributions is discussed in the context of the relationship between the average methylation and 5HTTLRP genotype. Philibert et. al. (2007) identified a transcript of the serotonin reuptake transporter (known as 5HTT) whose level of expression varies in relation to a noncoding SNP polymorphism. Closer study revealed that promoter DNA methylation patterns are related to the level of expression of the mRNA, with the highly methylated variants showing lower levels of transcription of the 5HTT mRNA. When the data is plotted taking into consideration the SNP genotypes (FIG. 5), the distribution of the methylation level is suggestive of a genotype-related association at a CpG island near the promoter of the gene. However, the data for the heterozygous (1s) samples is difficult to interpret unambiguously as two independent distributions. The problem is that the SNP is located about 2300 bases away from the CpG island, and therefore Philibert et, al. were unable to show direct physical linkage of the SNP and the DNA methylation changes. This is an example of a genetic association study where an assembly of long hepitype structures would serve to clarify the possible linkage of genetic and epigenetic structures associated with the two discrete mRNA expression phenotypes.

There exist alleles that confer susceptibility to modification of DNA methylation by environmental exposures, and these have been called “metastable epialleles”. This phenomenon has been demonstrated experimentally in mice with the “viable yellow” Avy agouti allele (Morgan et al., 1999; Waterland and Jirtle, 2003). The expression of this allele produces a yellow coat color, obesity, diabetes and susceptibility to cancer. Extensive variation in phenotype is produced by differential methylation of the Avy promoter. The degree of Avy promoter methylation is transmitted from mother to offspring such that pseudoagouti female mice, who have the same genotype as yellow agouti females but are characterized by normal coat color and body weight attributable to epigenetic silencing of the Avy promoter, give birth to a higher percentage of pseudoagouti offspring compared with yellow agouti females (Wolff; 1978). Notably, modifications in the expression of Avy agouti allele may be produced through dietary intake of methionine, such that, among offspring born to mothers placed on high methionine diets, there is a shift toward a pseudoagouti phenotype (Wolff et al., 1998; Waterland and Jirtle, 2003). Thus, the degree of Avy promoter methylation and hence agouti phenotype may be passed from one generation to the next via maternal epigenetic inheritance but may also be modified by maternal environment. Without wishing to be bound by any particular theory, it is believed that there exist many other loci, particularly in humans, where environmental factors may affect the extent of DNA methylation, and potentially the patterns of gene expression. The generation of LHD data would facilitate the description in humans of so far undiscovered loci with similar complex behavior, and the elucidation of mechanisms of disease that may be strongly influenced by environmental factors, such as type II diabetes and metabolic syndrome. LHDs could facilitate the elucidation of genetic association of complex human traits involving metastable epialleles.

DNA methylation information may be exploited to elucidate ancestry and number of divisions, as illustrated in a study by Kim et. al., (2005). Kim et. al., recorded the distance between different methylation strings obtained using sodium bisulfite sequencing of promoter loci. They were able to show that cells of the colon have a longer mitotic age (they have undergone more cell divisions) than cells of the small intestine. Drift due to errors in DNA methylation could be used to infer lineage and mitotic age at the level of haplotype blocks, instead of at the level of a promoter region. The information-richness of DNA methylation strings in LHDs has the potential to generate even more precise lineage ancestry information. Without wishing to be bound by any particular theory, it is believed that LHDs may serve to elucidate lineage relationships and mitotic age among different cells.

### Example 4

### LHD as a Descriptor to Drug Treatment

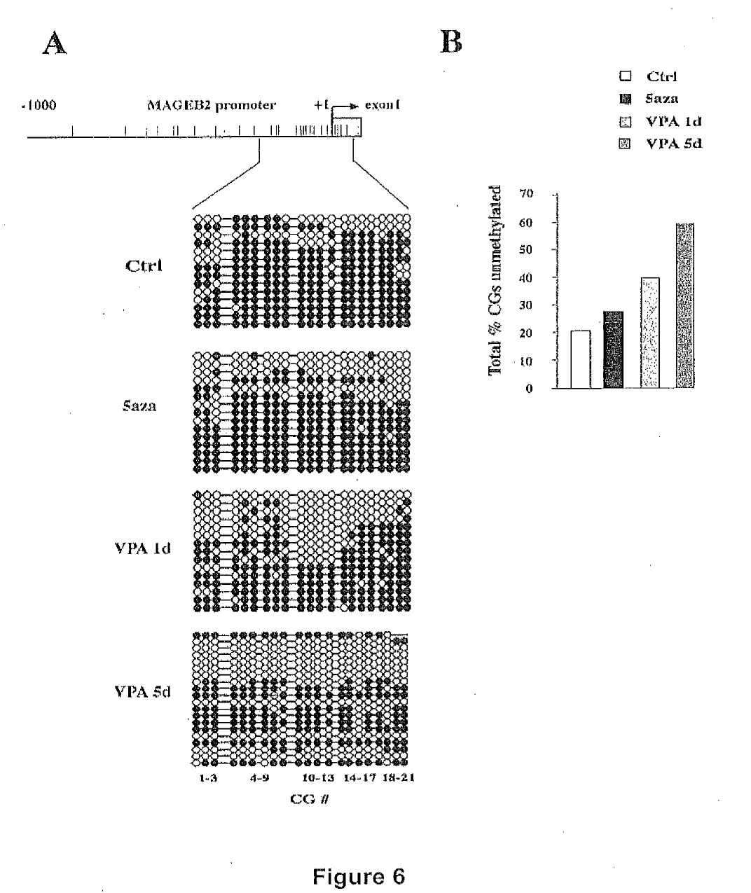

In the field of pharmacogenomics, the ability to generate the precise structures of LHDs provide a new and powerful tool to elucidate the variation in responses to drugs of different individuals with different genetic constitutions. For example, a class of drugs that affects DNA methylation is widely used in the treatment of bipolar disorder and other psychiatric conditions. Multiple studies have documented these effects, primarily using human cell culture models. For example, a recent study by Milutinovic et al (2007) examined the effect of Valproic acid (VPA) and 5-aza-guanosine on the methylation patterns of the MAGEB2 promoter and the MMP2 promoter. FIG. 6 shows the methylation profiles obtained for the MAGEB2 promoter. Treatment with Valproic acid (VPA) for 1 day or 5 days results in changes DNA methylation profiles. The methylation profiles observed after VPA treatment exhibit a bimodal distribution that could reflect the existence of two different (undiscovered) allelic backgrounds at this locus, at the haplotype level. It is believed that the results may reflect yet-to-be-discovered hepitypes. The use of the method of the present invention would allow the elucidation of LHDs that may serve as digital descriptors of genotype-associated heterogeneous responses of individual DNA strands, in different cells, to different drug treatment dosages and regimens.

### Example 5

### Evidence of Hepitype-Disease Associations

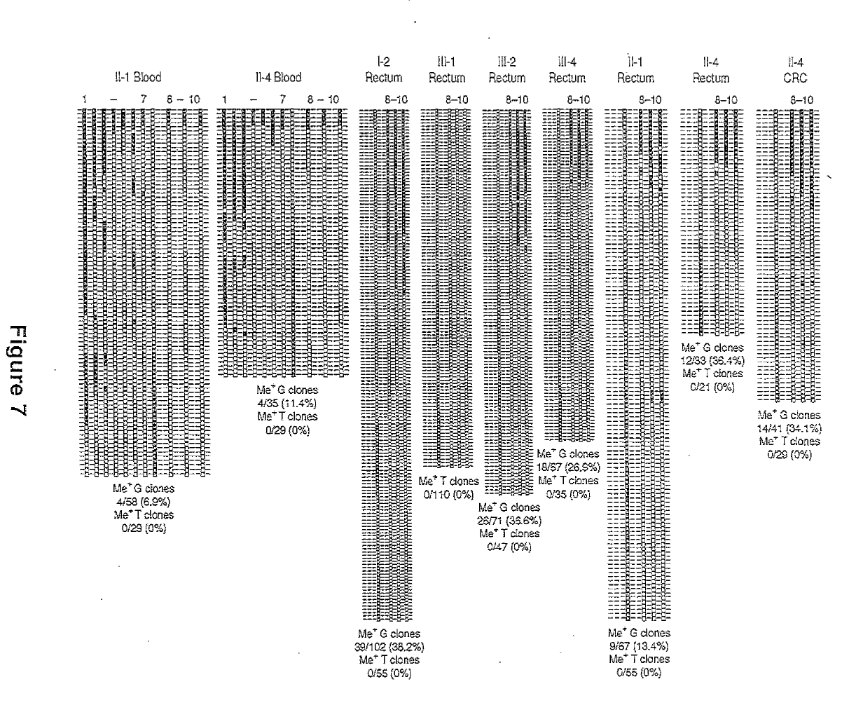

The next set of experiments was designed to determine whether there are any direct evidence that specific haplotypes may generate hepitype heterogeneity in tissue, and that abnormal hepitypes may be correlated with disease. An example may be found in a recent study of families with a high incidence of colon cancer, where epigenetic abnormalities could be demonstrated for the MSH2 gene (Chang et al., 2006). A heterogeneous distribution of hepitypes, shown in FIG. 7, were associated with a promoter-proximal SNP, and with silencing of the MSH2 gene. Patients with the abnormality-associated SNP displayed tissue mosaicism for the MSH2 (mismatch repair) protein expression in the colon. Lymphocytes also displayed the heterogeneous hepityptes, but in blood cells the abnormal, highly methylated hepitype was observed with much lower frequency than in the colon, and thus the risk of mismatch repair deficiency is significantly tissue-specific.

### Example 6

### Whole Genome Analysis of LHDs

The next set of experiments was designed to consider the data structures that would emerge from genome-wide analysis of LHDs. Assuming that the human genome contains approximately 28,000 transcriptional start sites (TSS), and that 25% of these TSS would be subject to variation in LHDs among population and tissues, it is believed that a total of 7,000 loci for hepitypes is needed for the analysis. Using domain knowledge (from EST databases and gene expression profiles) about different tissues, the sampling may be reduced to a limited set of 3000 TSS. At the level of a single tissue type, and in the context of disease or drug responses, it is believed that perhaps 5% of these loci would display fluctuations in LHDs, for a total of 150 informative (changing) hepitypes. A set of tables of the relative frequencies of these 150 fluctuating hepitype loci (in each different patient) may be created as shown below:

### Example 7

### Multi-Locus Holocomplement Structure

A holocomplement is the collection of all the co-resident hepitypes in a diploid chromosome complement, within the nucleus of a single cell, or in a homogeneous population of cells closely related by lineage. The holocomplement of each cell gets scrambled during DNA extraction of tissue. The reconstruction of each holocomplement may be achieved by observing correlations among fractional states in the tables of genome-wide hepitype frequencies using maximum parsimony approaches. For example, in the hypothetical data set shown in Table III, there is a likely correlation among the frequencies of: 1.1.1 and 5.2.1; 1.1.2 and 5.2.2; 1.2.1 and 5.1.1. Some correlations could reflect epistatic interactions that stabilize specific holocomplements that are a combination of compatible hepitype states. The relative frequencies of the alternative hepitypes 1.1.1 or 1.1.2 in relation to 5.2.1 and 5.2.2 may reflect a mosaic cell population structure in tissue, with different holocomplements among members of the mosaic (see further analysis in Table V). Holocomplements, epistatic interactions, and mosaic cell populations may be better validated using more developed hepitype-specific imaging biosensors that could report simultaneously the DNA hepitype status of several loci of interest at single-cell resolution.

TABLE III
Relative frequencies of long hepitypes that vary
among patient data sets
Locus. Haplotype. Hepitype - frequencies in
2 separate patients (see analysis in Table V)

| | | | |
|---|---|---|---|
| 1.1.1 | 0.20 | 0.00 | cell mosaicism in first column, for 1.1.1 and 1.1.2 |
| 1.1.2 | 0.30 | 0.50 | |
| 1.2.1 | 0.50 | 0.50 | |
| 1.1.1 | 0.50 | 0.50 | homozygous heterohepitype |
| | | | (epigenetic effect of imprinting) |
| 2.1.2 | 0.50 | 0.50 | homozygous heterohepitype |
| | | | (epigenetic effect of imprinting) |
| 3.1.1 | 0.50 | 0.50 | |
| 3.2.1 | 0.00 | 0.50 | promoter silencing compatible with |
| | | | 4.1.1 - based on network knowledge |
| 3.2.2 | 0.50 | 0.00 | |
| 4.1.1 | 0.00 | 0.50 | promoter silencing compatible with |
| | | | 3.2.1 - based on network knowledge |
| 4.1.2 | 0.50 | 0.00 | |
| 4.2.1 | 0.50 | 0.50 | |
| 5.1.1 | 0.50 | 0.50 | |
| 5.2.1 | 0.22 | 0.00 | cell mosaicism in first column, for 5.2.1 and 5.2.2 |
| 5.2.2 | 0.28 | 0.50 | . . . and so on up to 150.2.1 |

### Example 8

### Utility of LHDs to Define Molecular Phenotypes in a Population Study, Using DNA Obtained from Tissues of Aging Patients

Gene expression profiles have been used as adjunct metrics for defining quantitative phenotypes in studies of complex diseases. Expression profiles may generate additional domain knowledge that helps to elucidate which pathways and regulatory networks may be operating abnormally in any given disease context, and thereby point to a subset of potentially more relevant SNPs. Without wishing to be bound by any particular theory, it is believed that LHD statistics may serve as another important layer for describing quantitative phenotypes. Compared to gene expression profiles, LHDs are rich in information about the fine-grained structure of tissue, since they are based on information derived from single strands of DNA, and ultimately, single cells. In diseases that manifest themselves with increased frequency in old age, such as metabolic syndrome or dementias, the variation in properties of individual haplotypes within individual cells, as represented by LHDs, become of paramount importance. The LHD data structures allows phenotype to be defined cell-by-cell, often including bonus information bits about lineage, mitotic age and environmental insults recorded in the DNA strand hepitype phylogenies as regulated epigenetic variation, or disturbance-induced noise.

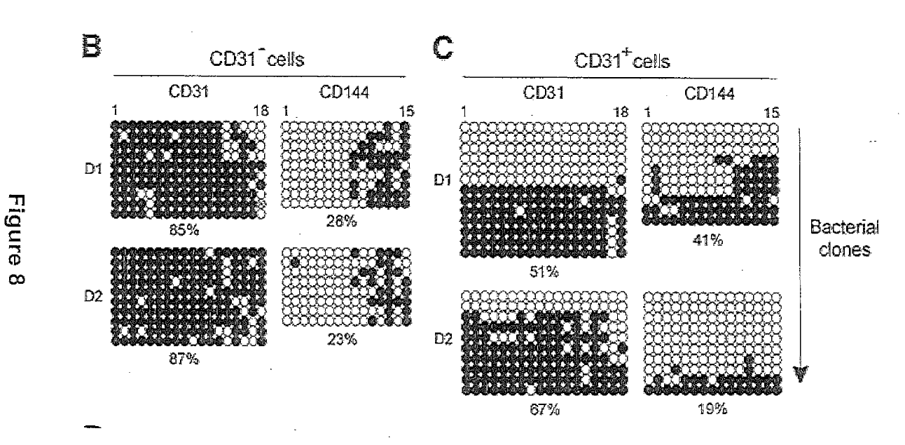

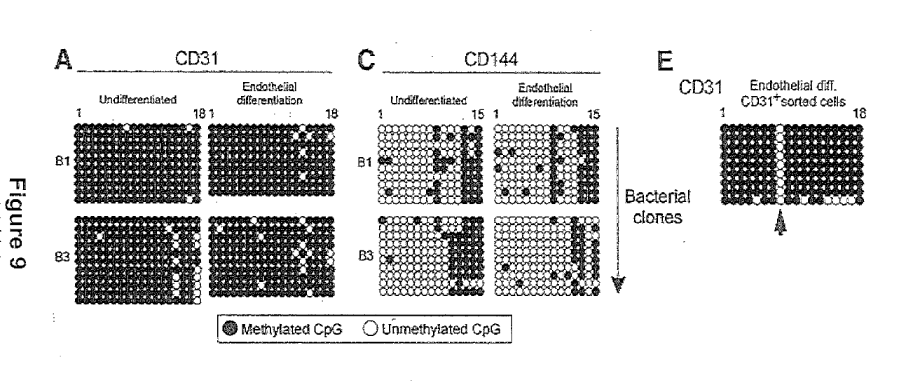

By way of a non-limited example, utility of LHD is described in the context of mosaic phenotypes that occur in preadipocytes and adipocytes in obsess or aging individuals. A recent study by Boquest et al., (2007) investigated the DNA methylation sequences present near the promoter regions of two endothelial cell-specific genes, CD31 and CD144, during differentiation of adipose stem cells. CD31− and CD31+ cells were obtained (by cell sorting) from two different donors. The DNA methylation patterns (FIG. 8, panels B and C) show that the CD31 promoter is highly methylated in CD31− cells, while in CD31+ cells some methylation is lost, resulting in two different distributions, probably representing hidden hepitype patterns that would emerge if more DNA methylation sequence information were available for alignment and LHD construction. FIG. 9, from the same study, shows patterns of methylation from undifferentiatied adipose stem cells (panel A), from stem cells induced to undergo endothelial differentiation (again panel A), and finally from fully differentiated endothelial cells (panel E). In the fully differentiated endothelial cells, there is one methylation position (#8) that flips completely to the unmethylated state in all clones sequenced, indicating a lineage-specific change in methylation profiles. It should be apparent from these patterns that DNA metylation information may be informative with respect to the phenotype of a given tissue type (CD31− vs CD31+ adipose stem cells), as well as with respect to the current state of differentiation (adipose stem cells vs endothelial cells).

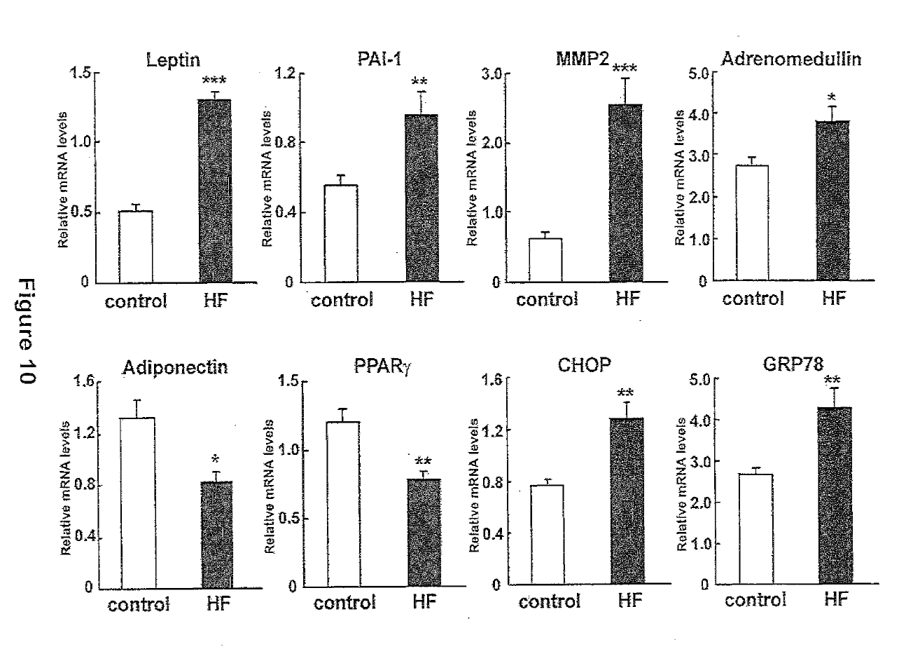

Given the capability for recognition of a subtraction of cells in tissue using LHD information, one may imagine tackling mosaic phenotypes such as would occur in the generation of abnormal sub-populations of preadipocytes and adipocytes in obese or aging individuals. Obese mouse models have been used to show hypoxia responses in mice fed high fat diets (Hosogai et al., 2007). The response of adipocytes to hypoxia conditions involves the overexpression of a number of hypoxia-inducible genes, including leptin and MMP2 (see FIG. 10). Experiments were designed to detect hypoxia phenotypes in adipose tissues form patients where the fraction of adipocytes suffering from hypoxia is relatively small (Table IV). It is apparent that, due to the dilution effect, mRNA expression changes indicative of the hypoxia response are detectabled in no more than 2 samples. In some instances, it would be difficult to isolate the hypoxia-responsive cells. By contrast, the use of LHD data, based on 60 DNA methylation sequences, would easily detect methylation changes when the hypoxia response involves as few as 5% of the cells. The LHD data is obtained from total tissue samples, without cell fractionation, and the data would be informative for the leptin promoter, as well as the MMP2 promoter, both of which are know to undergo DNA methylation changes upon activation by hypoxia. Without wishing to be bound by any particular theory, it is believed that this analysis would be extensible to hundreds or even thousands of LHD loci, as granular epigenetic correlates of haplotype blocks.

TABLE IV
Hypothetical experiments designed to detect mRNA expression
in adipose tissue for an mRNA whose expression increases
5-fold under hypoxia, or for an LHD marker whose methylation
distribution changes under hypoxia, in patients where the
hypoxia fraction of adipose tissue is small, as indicated
in the second column.

| | hypoxia | | | | detectable |
|---|---|---|---|---|---|
| | fraction | | | detectable | by LDH |
| | of adipose | expression | change after | by RNA | (60 |
| proband | tissue | change | dilution | expresion | sequences) |
| 1 | 0.15 | 5 | 1,60 | | yes |
| 2 | 0.10 | 5 | 1.40 | | yes |
| 3 | 0.03 | 5 | 1.12 | | ? |
| 4 | 0.25 | 5 | 2.00 | yes | yes |
| 5 | 0.08 | 5 | 1.32 | | yes |
| 6 | 0.10 | 5 | 1.40 | | yes |
| 7 | 0.20 | 5 | 1.80 | yes | yes |
| 8 | 0.12 | 5 | 1.48 | | yes |
| 9 | 0.10 | 5 | 1.40 | | yes |
| 10 | 0.07 | 5 | 1.28 | | yes |

### Example 9

### Information Revealed Through the Use of LHDs

An article by Yagi et al. (2008) describes studies on the DNA methylation profiles of tissue-dependent and differentially methylated regions near mouse gene promoters. The study utilizes Affymetrix chips that survey DNA methylation in an interval extending from −6 Kb to +2.5 kb relative to the known transcriptional start sites of mouse genes. The analysis demonstrated that a large proportion of the genes studied showed good correlation between their tissue-specific expression and their DNA methylation status. Examination of the data presented by Yagi et al. shows an interesting pattern of DNA methylation. However, the data was generated from 5 different PCR amplicons, located at different genomic positions, and therefore did not contain any known physical linkages. For example, there is no data linking the sequences in boxes 1, 2, 3, 4 or 5 set forth in Yagi et al.

LHD analysis of liver tissue according to the methods discussed elsewhere herein would comprise DNA methylation information that would be linked across the entire region encompassing boxes 1, 2, 3, 4, and 5. In fact, the LHD data structure would extend even further, possibly as long as 250 kilobases across this genomic region. The LHD data structure would reveal if the liver DNA methylation indeed comprises two different classes of methylation profiles, one mostly consisting of unmethylated and the other consisting of methylated. The data disclosed in Yagi et al., suggests that the methylated material in the liver comprises approximately 10% of the DNA. Without wishing to be bound by any particular theory, it is believed that the unmethylated profiles could represent hepatocyes, while the methylated profiles could be derived from stellate cells, which represent 5% to 8% of the cells in normal mouse liver. If the liver is suffering from fibrosis, the number of stellate cells could increase to 12% or even 15% in an extreme case.

The LHD data structure may also be applied to studies on drugs to reduce liver fibrosis. In this situation, it would be useful to have information about the status of stellate cells. A pathologist could examine the mouse liver tissue and report on the number of stellate cells. A molecular biologist could dis-associate the liver tissue and isolate some of the stellate cells. A molecular biologist could perform a study similar to the one published by Yagi et. al., and observe the MVP information, but not be able to associate it to the tissue stellate cell composition. The sequence information in box 4, which comprises 10 columns of information (or 10 MVPs) fails to provide information that the profile is arising from a subset of cells. Unlike the LHD analysis, a primitive DNA methylation analysis such as that shown in FIG. 4 from the Yagi article would fail to reveal the cellular subcompartment structure of tissue.

Alternatively, one could isolate total liver DNA and use long-read DNA methylation analysis to observe the DNA methylation status of a set of genomic regions, and then assemble a multiplicity of long reads using sequence alignment algorithms to generate long hepitypes. One would use appropriate statistical tools such as markov chains to generate LHD data structures. The LHD analysis could conceivably reveal the presence of liver stellate cells though the correspondence of the LHD data to reference Hepitype data previously generated for isolated liver stellate cells. The reference Hepitype data, connected to the LHD data structure though a linear linkage relationship, may be informative of cell lineage. This analysis, based on the current invention, would reveal drug responses in the fibrotic liver occurring within stellate cells that represent a small sub-population of the liver tissue, without the need to examine the tissue in a microscope, nor the need to purify stellate cells for RNA expression analysis.

A skilled artisan when armed with the present disclosure would appreciate how LHD data structures could be used for reverse phenotyping in genome-wide associated studies (GWAS). The LHS data structures would serve as reverse genotypes, and these reverse genotypes would be very rich in their information content (gene expression, cell lineage, environmental exposures), as follows: a) alternative states of LHD methylation profiles, corresponding to relative transcriptional activities or even alternative splicing patterns; b) bits of methylation information, embedded in the LHD data structure that are informative as to lineage and mitotic history (these bits permit the identification of cell sub-populations in tissue (i.e. quiescent stellate cells), or diseased meta-populations (i.e. activated stellate cells) within any sub-population); and c) noise in the methylation bits of liver hepatocytes or live stellate cells, resulting from environmental exposure to alcohol or other liver toxicants.

Based on the disclosure presented herein, a skilled artisan would understand the applications of LHD in GWAS experiments as follows. It is widely recognized that imprecise phenotype descriptors are a major limitation that reduces the power of GWAS studies. Furthermore, the inability to observe the phenotype present in minority cell subpopulations, where disease may be most acute, is a major cause of low power for detection of phenotype/genotype association. Additionally, the unwillingness of individuals to provide accurate information regarding substance abuse may be a huge factor masking relevant environmental exposures such as alcohol use or abuse. The LHD data structures of this invention could even reveal environmental exposures that individuals are not aware of, such as exposure to arsenic in water, which is known to induce characteristic DNA methylation alterations in the liver and other tissues. While liver tissue is unlikely to be available for use in a GWAS human population, it may be possible to use skin cells or peripheral lymphocytes as tissues where environmental exposures may be revealed at the DNA methylation level. Without wishing to be bound by any particular theory, it is believed that different environmental exposures could be correlated with different LHD signatures, and that these signatures could serve as reverse phenotypes for GWAS experiments.

### Example 10

### Drug Discovery

A drug company may be interested in understanding which genes and genomic control elements (noncoding regions) are associated with, for example, familial asthmatic conditions or asthma susceptibility in the general population. Such information would help the company to develop and bring to market superior asthma drugs.

The company would sponsor a study of cases and controls, performing SNP analysis in a sufficient number of individuals. The company would assemble a very favorable and optimized cohort design, and would additionally perform for each subject a whole-genome DNA methylation analysis of brushings of bronchial cells. The purpose of obtaining the whole-genome DNA methylation data in this study is its potential utility in generating a set of “reverse phenotypes” (Schulze and McMahon, 2004). In the reverse phenotyping approach, the DNA methylation data, in the form of LHDs would be used to drive, or form the basis of new, highly accurate phenotype definitions. In some instances, reverse phenotyping allows for the identification of novel molecular signatures of the disease state. The goal to define phenotypic (LHD) groupings among the test subjects, the groupings being distinguished by higher rates of SNP or haplotype allele sharing (linkage data), or more deviant allele frequencies (linkage disequilibrum in association data). These rates of sharing, or alternatively, disequilibrum, may be much higher than those calculated using the traditional clinical descriptors of asthma (or any other complex disease).

A useful way to think about LHD reverse phenotype information is to think of the LHD data as a “chromatin state” across a long domain which may encompass one or several genes within in a single chromatid, encompassing the entire size of a SNP haplotype cluster, that is, 20 to 250 kilobases. For imprinted gene loci, the LHD distribution would show a minimum of two states, an active locus and a silent locus. For the human globin cluster, which is about 30 kilobases in length, potential LHD structures could comprise a minimum of three possible states, as suggested by data published by Hsu et al (2007) where there seem to be distinct DNA methylation patterns for primitive embryonal cells, fetal liver, and adult bone marrow, respectively. The short DNA reads generated in this study would not permit the generation of LHD data structures, but nonetheless suggests the existence of three or more methylation “epi-phenotypes” across a 30 kb long domain in the genome.

The methods of this example generally comprise the following procedures. Initially, DNA is isolated from a sample, for example, from peripheral lymphocytes of about 500 cases and controls. The DNA is then subjected to SNP analysis using SNP chips containing about one million SNPs. In some instances, DNA is isolated from brushings of bronchial cells from the same 500 cases and controls, and the sample is processed for DNA methylation analysis.

DNA methylation analysis of deaminated DNA is performed using a method that is capable of generating DNA sequencing reads longer than 4000 bases, such as the method developed by Pacific Biosciences in Menlo Park, Calif. DNA sequencing oversampling is set as 25×. The next step comprises aligning the resulting genomic DNA sequences to the human genome, using a reference genome where CG is converted to TG to simulate deamination of cytosine. Then local alignment of the sets of 25× oversampled DNA methlylation sequences is performed in order to build large scaffolds, using a “greedy algorithm” that maximizes alignment of the CpG dinucleotides where the methylation state is the same, thus building hepitypes. Extension of the contigs of each of the scaffolds is performed in order to build long hepitypes.

After all the long hepitypes are assembled, they are organized in ungapped sets, and generalized Markov chain analysis is performed to generate long hepitype Distributions that describe the statistical properties of distinct, long patterns of methylation strings residing in single DNA chromatids.

Regions in the genome where the LHD data structures are found to be markedly distinct (using a suitable Markov chain distance metric) from the LHD data structures of tissue from normal (control) individuals are flagged as candidate reverse phenotypes. Since each LHD typically is ˜100 kb in length, the genome contains approximately 30,000 LHDs, and perhaps 1% of these may show recurrently altered LDH statistical distributions in asthmatic subjects, for a total of 300 potential reverse phenotype asthma biomarkers. Statistical analysis (a Wilcoxon test) is used to rank the candidate LHDs as to potential association with asthma. It is believed that some of the marker LHDs may correspond to Markov chains that represent minority components (as low as 4%) of the epithelial brushing cell population. The detection of these LHD phenotypes is made possible by the 25× oversampling used for DNA methylation sequencing. It is believed that 50× oversampling could detect a 2% component.

Linkage analysis is performed, using the SNP information as well as combined SNP haplotypes from the SNP chip analysis, and using the most informative subset of LHD information, one by one, or together, as quantitative disease phenotypes for asthma.

Deviant allele frequencies (disequilibrum) for whole genome association is performed, using the SNP information as well as combined SNP haplotypes from the SNP chip analysis, and using the most informative subset LHD information, one by one, or together, as quantitative disease phenotypes for asthma.

A result of the analysis discussed above is that genomic SNPs/haplotypes associated with LHD disease phenotypes are identified. The process may be repeated for a second, independent sample of another 500 cases and controls.

### Example 11

### LHD Holocomplement Matrix Analysis (LHD-MA)

The next set of experiments was designed to reconstruct individual holocomplement from sequence data and a multiplicity of LHD data structures obtained from a mixture of cells. The disclosure presented herein demonstrates a method for deducing cell population structures, based on a data set comprising a multiplicity of LHDs. Table V illustrates a likely population structure deduced from a set of LHDs, using data similar to that shown in Table III. The data in Table V represents a somewhat more complex hypothetical situation. Table V shows a reconstruction of the most likely population structure (Populations A, B, C) of different cells in a tissue sample (Patient 1), by means of LHD holocomplement Matrix Analysis, which is a method for discovery of correlation structures observed among a multiplicity of LHD data structures obtained from one or more biological samples (same hypothetical data set was shown earlier in Table III). Locus 2 is an imprinted gene locus, with abnormal loss of imprinting in 14% of cells in Patient 2. The analysis could additionally include phylogenetic tree analysis of methylation bits.

TABLE V
Locus. Haplotype. Hepitype - this is the nomenclature
in column 1 of the table

| | | | Cell populations in Patient 1 | | |
|---|---|---|---|---|---|
| | Patient1 | Patient2 | Pop A | Pop B | Pop C |
| | Freq1 | Freq2 | (18%) | (32%) | (50%) |
| 1.1.1 | 0.09 | 0.00 | 1.1.1 | | |
| 1.1.2 | 0.41 | 0.50 | 1.1.2 | 1.1.2 | |
| 1.2.1 | 0.50 | 0.50 | 1.2.1 | 1.2.1 | 1.2.1 |
| 2.1.1 | 0.50 | 0.57(LOI) | 2.1.1 | 2.1.1 | 2.1.1 |
| 2.1.2 | 0.50 | 0.43(LOI) | 2.1.2 * | 2.1.2 * | 2.1.2 |
| 3.1.1 | 0.50 | 0.50 | 3.1.1 | 3.1.1 | 3.1.1 |
| 3.2.1 | 0.25 | 0.50 | | | 3.2.1 ** |
| 3.2.2 | 0.25 | 0.00 | 3.2.2 *** | 3.2.2 *** | |
| 4.1.1 | 0.25 | 0.50 | | | 4.1.1 |
| 4.1.2 | 0.25 | 0.00 | 4.1.2 *** | 4.1.2 *** | |
| 4.2.1 | 0.50 | 0.50 | 4.2.1 | 4.2.1 | 4.2.1 |
| 5.1.1 | 0.50 | 0.50 | 5.1.1 | 5.1.1 | 5.1.1 |
| 5.2.1 | 0.09 | 0.07 | 5.2.1 | | |
| 5.2.2 | 0.41 | 0.43 | | 5.2.2 | 5.2.2 |

* silent hepitype
** The 3.2.1 hepitype is incompatible with hepitypes 1.1.1 and 5.2.1, based on network knowledge
*** 4.1.2 is correlated with 3.2.2 based on gene expression profile knowledge
**** NOT included in the table is the analysis of lineage structures derived from LHD methylation bits
LOI = Loss of Imprinting in Patient 2 apparently causes hepitype switching from 5.2.2 to 5.2.1

### Example 12

### A Disease-Association Study on Metabolic Syndrome

The following experiments were designed to apply the concept of LHDs in the context of performing a genetic association study on the incidence of metabolic syndrome in the elderly.

Biopsy of several adipose tissue samples from each patient in a population of cases and controls is obtained. The samples are process and DNA extraction and genome-wide bisulfite sequencing using long DNA-read technology is conducted. Once sequencing information is obtained, LHD structures at thousands of loci by alignment of the methylation DNA sequences from each sample is constructed.

Based on the disclosure presented herein, identification of normal/abnormal preadipocytes or normal/abnormal adipocytes based on comparison of patient LHD data to reference LHD data from normal adipocytes and normal preadipocytes may be accomplished. The LHD data would involve a subset of selected informative LHDs, selected among all LHDs as those LHD markers that yield the best results in normal/abnormal class comparison tests. Stratification of tissues and patients based on LHD statistics and proposed multi-locus holocomplement structures from multiple LHD loci in the genome are then conducted. In some instances, it is preferred to combine the LHD statistics and multi-locus holocomplement structures with additional genetic information (e.g., SNPs, gene expression).

Without wishing to be bound by any particular theory, it is believed that analysis of the data could reveal a situation where the severity of disease (for example, an insulin resistance phenotype) may be correlated with the individual locus LHD cell population structure in different tissue samplings, as well as multi-locus holocomplement structures of adipose tissue. A hypothetical epigenetic association of the insulin resistance could be correlated with a specific subset of LHDs, where the different LHDs are either independent, or alternatively epistatically connected epigenetic markers. Identification of changes in the fine structure of LHD in the genome-scan would reveal the subtle epigenetic mosaicism of the tissue, whereby a fraction of the cells are abnormal (for example, as shown in Table V, the abnormal population A, representing 18% of the cells in Patient 1, or the LOI abnormality present in 14% of the cells in Patient 2) which would otherwise be difficult to detect in the absence of knowledge about specific candidate genes.

In some instances, it is desirable to identify loci in the genome that show strong association with disease, where the loci could not have been discovered without the ability of LHD to reveal the abnormal epigenetic events in a minor compartments of adipose tissue.

The disclosure presented herein demonstrate the ability to identify a likely mechanistic basis for the metabolic syndrome disease phenotype, based on the LHD phenotypes of a subset of adipocytes in adipose tissue, and a subset of cardiomyocytes in heart tissue, with links to mosaic tissue responses to inflammatory stimuli.

### Example 13

### A Drug-Response Study in Liver Regeneration Under the Influence of a Drug

In humans, chronic infection with hepatitis C virus may induce liver cirrhosis. It would be desirable to help these patients regenerate a new liver, but if regeneration is initiated by pluripotent cells from within the liver, there will be a greater risk of liver cancer, since such cells may be genetically damaged due to the chronic viral infection.

Pre-clinical rodent models are subjected to reduction in liver size by partial hepatectomy, followed by liver regeneration under the influence of a drug that stimulates liver regeneration. The objective is to test if the drug may induce a bias in liver regeneration, whereby bone marrow cells have a predominant role in re-populating the liver. These drugs would then be tested in humans to achieve regeneration mediated by bone marrow cells. LHD may be applied to a drug-response study as follows.

Biopsy of liver tissue samples at several time points with or without drug treatment is collected. The samples are processed and subjected to DNA extraction and genome-wide bisulfite sequencing using long DNA-read technology. LHD structures at thousands of loci by alignment of the methylation DNA sequences from each sample are constructed using the methods discussed elsewhere herein. Once LHD structures are constructed, identification of candidate cell sub-populations based on statistical analysis of metapopulations (deme reconstruction) of multi-locus LHD data may be accomplished. The LHD data would involve a subset of selected informative LHDs, selected among all LHDs as those LHD markers that yield the best results in generating a classification of cell sub-populations.

LHD information has at least three major components relevant to this study: a) the alternative states corresponding to relative transcriptional activities at promoters; b) the bits of methylation information that are informative as to lineage and mitotic history (these bits permit the identification of cell populations originating from a bone marrow lineage); and c) noise in the methylation bits of liver cells resulting from the prolonged exposure to viral infection and inflammatory cytokines. In some instances, it is desirable to combine the LHD statistics and multi-locus holocomplement structures with additional phenotype information (e.g., gene expression analysis of cells from the liver using surface markers).

A hypothetical epigenetic association of drug-induced liver regeneration may be correlated with a specific subset of LHDs, where the different LHDs are either independent, or alternatively epistatically connected epigenetic markers. Identification of changes in the fine structure of LHD in the genome-scan would reveal a sub-population of hepatocytes that originated from hematopoietic precursors in the bone marrow, and distinguish this population from a separate population of hepatocytes derived from pluripotent cells from within the liver.

The disclosure presented herein demonstrate the ability to identify a likely mechanistic basis for drug action, based on the multi-locus LHD phenotypes of a subset of hepatocytes.

### Example 14

### Evaluation of Long Hepitype Assemblies in Human Chromosome 22

The following experiments were designed to evaluate long hepitype distributions in human chromosome 22 as a non-limiting example.

A list of known genes in chromosome 22 from HG17 reference human genome was obtained. From this list, genes which contained unknown sequence, for example sequence specified as NNNN . . . in their neighborhoods, were removed in order to have those genes with perfectly known sequences in their immediate neighborhood for further analysis. A final list contained about 892 genes neighborhoods.

The genes were separated into a list of positive strand genes and a list of negative strand genes. Using sequence coordinates, 40,000 bases of sequence upstream of start site were captured. Using sequence coordinates, 70,000 bases of sequence downstream of start site were captured. The total sequence window for each gene consisted of about 110,000 bases.

For each of the 892 gene neighborhoods, modified sequences were generated as follows:

$$\frac{to change approx 7 \% of CpG residues}{sed ' s \text{/} CGAC \text{/} NGAC \text{/} g ; s \text{/} CGAA \text{/} NGAA \text{/} {g}^{′}}$$

$$\frac{to change approx 19.4 \% of CpG residues}{sed ' s \text{/} CGA \text{/} NGA \text{/} {g}^{′}}$$

In silico sequence “reads” simulating different scenarios of read lengths ranging from 2,000 to 12,000 bases were generated. The reads were generated at 8× coverage over each region of 110,000 kilobases. A greedy alignment algorithm (Malign, Hugo Martinez, Nucleic Acids Res. 1988 16:1683-91) was used in order to generate alignments of each of the reads of a modified (methylated) sequence to reads of the original reference sequence, whereby the reference sequence register was skewed by ⅛ of the sequence read length. For example, if the sequence read was 8,000 bases, the skew was 1,000 bases to simulate 8× oversampling. Without wishing to be bound by any particular theory, it is believed that this deterministic skewing is not an accurate simulation of random sequence reads, but still gives a reasonable mimic of the actual process.

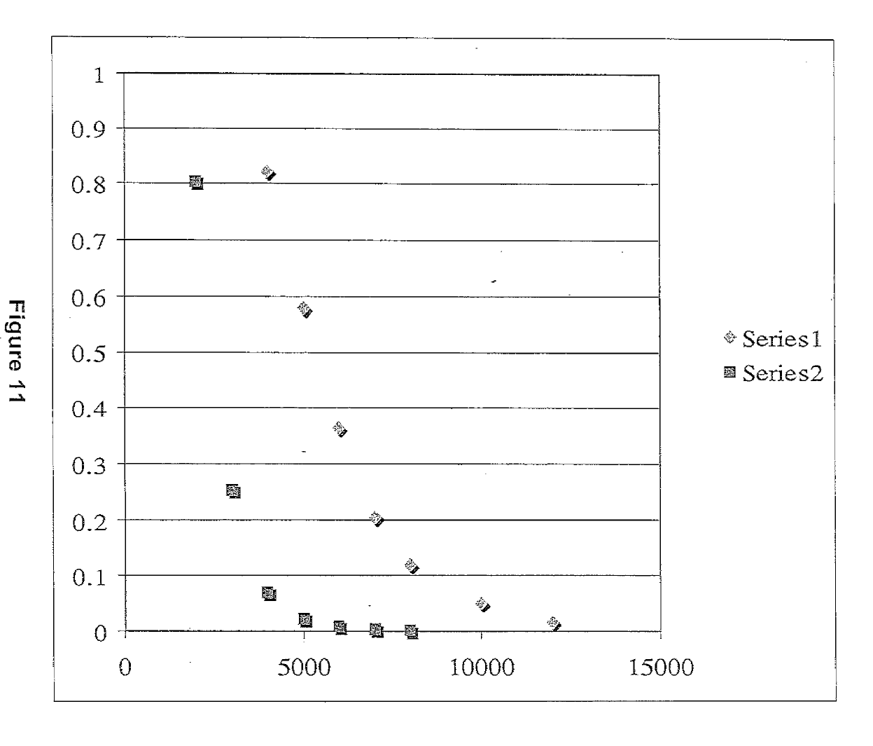

All alignments with a perfect score over the aligned read sequence interval, that is, a perfect alignment of 7,000 bases in the case of 8,000 base reads were collected. All the perfect alignments (which are by definition the non-discriminating alignments) of the sequence reads were then counted. At very long sequence reads, many genes achieved a situation where no perfect alignments were observed, indicating that there was sufficient information to discriminate the two different long hepitypes as individual chromatid strings over the entire 110 kb length of each gene neighborhood. Genes that failed to reach this stage were scored as comprising an “Incomplete assembly”. Finally, the fraction of genes with Incomplete assemblies were calculated, and plotted this as an Excel graph (FIG. 11). The curves showed a decrease in the failure rate of long hepitype string discrimination based on cytosine methylation information, as the DNA sequencing read length increases. For read lengths in the range of 2000 to 4000 bases, Incomplete assembly is a frequent event. For the case where 19.4% of CpG residues had simulated methylation changes, the number of Incomplete assemblies was zero as the read length reached 8,000 bases. For the alternative case where 7% of CpG residues had simulated methylation changes, the number of Incomplete assemblies was 14 (1.6% of 892 assemblies) as the read length reached 12,000 bases (Table VI; FIG. 11). These simple simulations demonstrate that LHD analysis is feasible for long DNA sequencing read lengths, for example read lengths that exceed 6,000 bases.

TABLE VI

| | failure | failure rate | | Incomplete | Incomplete |
|---|---|---|---|---|---|
| | rate 7% | 19.4% | total | Assembly, | Assembly |
| Read Length | variation | variation | 892 | 7% | 19.4% |
| (sequencing) | #IA/892 | #IA/892 | genes | variation | variation |
| 2000 | | 0.805 | | | 718 |
| 3000 | | 0.251 | | | 224 |
| 4000 | 0.823 | 0.070 | | 734 | 62 |
| 5000 | 0.577 | 0.022 | | 515 | 20 |
| 6000 | 0.363 | 0.007 | | 324 | 6 |
| 7000 | 0.204 | 0.003 | | 182 | 3 |
| 8000 | 0.119 | 0.000 | | 106 | 0 |
| 9000 | | | | | |
| 10000 | 0.050 | | | 45 | |
| 11000 | | | | | |
| 12000 | 0.016 | | | 14 | |

### Example 15

### Long Hepitype Distributions Based on More than Two Chemical Modification in DNA Sequences Obtained from the Brain

So far DNA sequences that may contain two alternative chemical states of a base in DNA, namely unmodified cytosine or 5-methyl cytosine, have been described herein. For this simple case, there are only two possible states for each cytosine base in a Long Hepitype Distribution. It follows logically that for a more complex DNA sequence that may contain three possible chemical states of cytosine (unmethylated cytosine, 5-methylcytosine, 5-hydrozymethylcytosine) it is also possible to use the methods described in each of the preceding examples to construct Long Hepitype Distribution from available DNA sequence data. Without wishing to be bound by any particular statistical framework, generalized Hidden Markov Models (gHMMs). Generalized Hidden Markov Models, which allow individual states to emit a string of symbols, parameterized by transition probabilities, state duration probabilities, and state emission probabilities (Majoros W H, Pertea M, Delcher A L, Salzberg S L, “Efficient decoding algorithms for generalized hidden Markov model gene finders.” BMC Bioinformatics. 2005 Jan. 24; 6:16.) may be referenced. The gHMM framework naturally extends to cases where the string symbols may comprise a larger number of symbols. C (cytosine), 5mC (methylcytosine), and 5hmC (hydroxymethylcytosine) are thus defined as valid symbols in a DNA sequence. Furthermore, A (adenine) and N6mA (N6-methyladenine) are defined as valid symbols in a DNA sequence.

In this example DNA sequencing data provides information regarding five alternative chemical states, namely C, 5mC, 5hmC, A, and N6mA. After generation of multiple sequence reads, this information is used with simple modifications of the greedy sequence alignment (more letters in the alphabet) and simple modifications of the gHMM statistical framework (more symbols in the strings).
1. Three cohorts of mice are used in an experiment designed to evaluate functional genomic alterations associated with memory impairment (Peleg S, Sananbenesi F, Zovoilis A, Burkhardt S, Bahari-Javan S, Agis-Balboa R C, Cota P, Wittnam J L, Gogol-Doering A, Opitz L, Salinas-Riester Dettenhofer M, Kang H, Farinelli L, Chen W, Fischer A. “Altered histone acetylation is associated with age-dependent memory impairment in mice.” Science, 2010 May 7; 328(5979):753-6.). The three cohorts consist of 3-month old mice, 8-month old mice, and 16-month old mice (young mature, old). Each of the cohorts is subjected to associative memory training using the Morris water maze protocol, as described by Peleg et al., 2010). This experiment generates 6 mouse populations, 3 untrained and 3 trained, for each group (young, mature, old).
2. The mice used in the experiment are heterozygous for alleles (sets of SNPs) near the promoter of the “Arc” gene, which is involved in memory consolidation. The mice are also heterozygous alleles near the promoter of REST/NRSF, the neuron-restrictive silencing factor,
3. Brain tissue comprising the hippocampus is dissected, and DNA is extracted from each tissue sample, resulting in 6 sets of pooled hyppocampus DNA preparations (3 untrained and 3 trained, for each group (young, mature, old)).
4. The DNA from each of the 6 preparations is sequenced using a Pacific Biosciences instrument, as described (Flusberg et. al., 2010). Sufficient sequencing is performed to generate 60-fold coverage by oversampling. The average read length obtained in the sequencing experiments is 6000 bases.
5. The DNA sequences corresponding to each of the 6 experimental cohorts is aligned using a greedy DNA sequence alignment algorithm, using an alphabet comprising 7 different letters A, G, C, T, 5mC, 5hmC, N6mA.
6. After alignment and resolution of the longest sequence alignment scaffolds, the alignments are organized to resolve the different allelic structures of genes present as heterozygous haplotypes/hepitypes.
7. The sequence data, including cytosine modifications, adenine modifications, and correlated SNP sequence information is used to generate Long Hepitype Distributions, described by a gHMM model for each experimental set.
8. The entire experiment is repeated in mice treated with a histone deacetylase inhibitor (SAHA) as described by Peleg et. al. (2010).
9. The experiment is repeated using mouse strains with different haplotype architectures for the neuronal genes of interest to the study.
10. The LHD information is used as reverse phenotypes to discern patterns of interest and particularly LHDs that may correlate with the responses of the young and old mice to drug treatment with SAHA. The LHDs can also be correlated with different populations of neurons in the hyppocampus, such as subsets of neurons that display LHD string typical of older mice, as well as LHD strings typical of younger mice.
11. A model describing neuronal aging as heterogeneous, and comprising the time-dependent evolution, via metapopulation dynamics of aging cellular patches in the hyppocampus, within a single mouse, is developed. The model may incorporate specific correlations with LHD strings that are identified as derived from “young” or “old” neurons, as well as “young” or “old” astrocytes, based on the power of LHD to deconvolute and discriminate discrete developmental lineages in brain using DNA methylation patterns (chromatin states).

The disclosures of each and every patent, patent application, and publication cited herein are hereby incorporated herein by reference in their entirety.

While the invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### REFERENCE LIST

Altshuler D, Daly M J, Lander E S. 2008 Genetic mapping in human disease. Science. 322:881-8. Review.
Boquest A C, Noer A, Sorensen A L, Vekterud K, Collas P. 2007 CpG methylation profiles of endothelial cell-specific gene promoter regions in adipose tissue stem cells suggest limited differentiation potential toward the endothelial cell lineage. Stein Cells. 25:852-61.
Butcher L M, Beck S. 2008 Future impact of integrated high-throughput methylome analyses on human health and disease. J Genet Genomics. 35:391-401.
Cartwright, M J, Tchkonia, T, & Kirkland J L 2007. Aging in adipocytes: Potential impact of inherent, depot-specific mechanisms. Experimental Gerontology 42: 463-471.
Chan T L, Yuen S T, Kong C K, Chan Y W, Chan A S, Ng W F, Tsui W Y, Lo M W, Tam W Y, Li V S, Leung S Y. 2006 Heritable germline epimutation of MSH2 in a family with hereditary nonpolyposis colorectal cancer. Nat Genet. 2006 October; 38(10):1178-83.
Flanagan J M, Popendikyte V, Pozdniakovaite N, Sobolev M, Assadzadeh A, Schumacher A et al. Intra- and interindividual epigenetic variation in human germ cells. Am J Hum Genet 2006; 79: 67-84.
Gabriel S B, Schaffner S F, Nguyen H, Moore J M, Roy J, Blumenstiel B, Higgins J, DeFelice M, Lochner A, Faggart M, Liu-Cordero S N, Rotimi C, Adeyemo A, Cooper R, Ward R, Lander E S, Daly M J, Altshuler D. 2002 The structure of haplotype blocks in the human genome. Science. 296:2225-2229,
Hsu M, Mabaera R, Lowrey C H, Martin D I, Fiering S. 2007 CpG hypomethylation in a large domain encompassing the embryonic beta-like globin genes in primitive erythrocytes. Mol Cell Biol. 27:5047-54.
Kim, J Y, Siegmund, K D, Tavare S., & Shibata, D. (2005) Age-related human small intestine methylation: evidence for stein cell niches. BMC Medicine 3(10):1-11
Hosogai, M, Fukuhara, A, Oshima, K, Miyata, Y, Tanaka, S, Segawa, K, Furukawa, S, Tochino, Y, Komuro, R, Matsuda, M, & Shimomura, I. 2007 Adipose Tissue Hypoxia in Obesity and Its Impact on Adipocytokine Dysregulation. Diabetes 56:901-911
Larijani M, Frieder D, Sonbuchner T M, Bransteitter R, Goodman M F, Bouhassira E E, Scharff M D, Martin A. 2005 Methylation protects cytidines from AID-mediated deamination. Mol Immunol. 42:599-604.
Mill J, Petronis A. 2007 Molecular studies of major depressive disorder: the epigenetic perspective. Mol Psychiatry. 1-16
Milutinovie, S, D'Alessio, AC, Deficit, N, & Szyf, M 2007 Valproate induces widespread epigenetic reprogramming which involves demethylation of specific genes. Carcinogenesis 28:560-571
Morgan, H. D., Sutherland, H. G. E., Martin, D. I. K. & Whitelaw, E. 1999 Epigenetic inheritance at the agouti locus in the mouse. Nature Genet. 23, 314-318
Murrell A, Rakyan V K, Beck S. 2005 From genome to epigenome. Hum Mol Genet. April 15; 14 Spec No 1:R3-R10.
Philibert R, Madan A, Andersen A, Cadoret R, Packer H, Sandhu H.2007 Serotonin transporter mRNA levels are associated with the methylation of an upstream CpG island. Am J Med Genet B Neuiopsychiatr Genet. 144:101-5.
Polesskaya O O, Aston C, Sokolov B P. Allele C-specific methylation of the 5-HT2A receptor gene: evidence for correlation with its expression and expression of DNA methylase DNMT1. J Neurosci Res 2006; 83: 362-373.
Schulze T G, McMahon F J, 2004 Defining the phenotype in human genetic studies: forward genetics and reverse phenotyping. Hum Hered. 2004; 58(3-4):131-8. Review.
Tchkonia, T., Tchoukalova, Y. D., Giorgadze, N., Pirtskhalava, T., Karagiannides, I., Forse, R. A., Koo, A., Stevenson, M., Chinnappan, D., Cartwright, A., Jensen, M. D., Kirkland, J. L., 2005. Abundance of two human preadipocyte subtypes with distinct capacities for replication, adipogenesis, and apoptosis varies among fat depots. Am. J. Physiol. 288, E267-E277.
Tchkonia, T., Giorgadze, N., Pirtskhalava, T., Thomou, T., DePonte, M., Koo, A., Forse, R. A., Chinnappan, D., Martin-Ruiz, C., von Zglinicki, T., Kirkland, J. L., 2006. Fat depot-specific characteristics are retained in strains derived from single human preadipocytes. Diabetes 55, 2571-2578.
Tchkonia, T., Lenburg, M., Thomou, T., Giorgadze, N., Frampton, G., Pirtskhalava, T., Cartwright, A., Cartwright, M., Flanagan, J., Karagiannides, I., Gerry, N., Forse, R. A., Tchoukalova, Y., Jensen, M. D., Pothoulakis, C., Kirkland, J. L., 2007. Identification of depot-specific human fat cell progenitors through distinct expression profiles and developmental gene patterns. Am, J. Physiol. 292, E298-E307.
Waterland, R. A. & Artie, R. L. 2003 Transposable elements: targets for early nutritional effects on epigenetic gene regulation. Mol. Cell. Biol. 23, 5293-5300.
Wolff, G. L. 1978 Influence of maternal phenotype on metabolic differentiation of agouti locus mutants in the mouse. Genetics 88, 529-539.
Wolff, G. L., Kodell, R. L., Moore, S. R. & Cooney, C. A. 1998 Maternal epigenetics and methyl supplements affect agouti gene expression in Avy/a mice. FASEB J. 12, 949-957.
Yagi 5, Hirabayashi K, Sato S, Li W, Takahashi Y, Hirakawa T, Wu G, Hattori N, Hattori N, Ohgane J, Tanaka S, Liu X S, Shiota K. 2008 DNA methylation profile of tissue-dependent and differentially methylated regions (T-DMRs) in mouse promoter regions demonstrating tissue-specific gene expression. Genome Res. 18:1969-78.

What is claimed is:

1. A method of generating a long hepitype distribution (LHD), the method comprising obtaining a biological sample having genomic DNA; obtaining the DNA from the sample; obtaining and analyzing a DNA sequence that includes the information of methylated bases in the DNA; repeating the DNA sequence analysis multiple times; and aligning a multiplicity of sequences with reference to variable bits of DNA methylation information, thereby generating one or more alignments, which collectively may be used to calculate statistics that describe a LHD.

2. The method of claim 1, wherein the methylated DNA sequences are larger than 3 kilobases.

3. The method of claim 1, wherein the probabilities of the presence or absence of methylated bases is described using markov chain statistics.

4. The method of claim 1, wherein the LHD comprises a group of sequence strings, wherein the group of sequence strings comprises DNA methylation and SNP information.

5. A method of generating a haplotype block long hepitype distribution, the method comprising extending an LDH until the length of the groups of aligned sequences approaches the length of an SNP haplotype block present at the corresponding genomic locus, wherein the LDH comprises a group of sequence strings, further wherein the group of sequence strings comprises DNA methylation and SNP information.

6. A diagnostic method for determining heterogeneity of a biological sample, the method comprising generating an LHD from a first and second biological sample, wherein the LHD comprises a group of sequence strings comprising DNA methylation and SNP information; comparing LHD from the first sample to LHD of the second sample, wherein a change of the methylation in the LHD from the first sample when compared with the LHD from the second sample indicates heterogeneity.

7. The method of claim 6, wherein the biological sample is a cell.

8. The method of claim 7, wherein the cell is a zygote.

9. The method of claim 8, wherein the zygote is an egg or sperm.

10. The method of claim 6, wherein the biological sample is a tissue.

11. A method of determining heterogeneity of a biological sample, the method comprising analyzing a large dataset from which different holocomplement components may be analyzed, wherein analyzing a large dataset comprises constructing individual holocomplements from sequence data and a multiplicity of LHD data structures obtained from a biological sample, and applying a maximum parsimony approach to deduce correlations among fractional states of genome-wide hepitype frequencies, thereby determining heterogeneity of a biological sample.

12. The method of claim 11, wherein the analysis further includes phylogenetic tree analysis of methylation string bits from DNA sequences from different loci.

13. The method of claim 11, wherein the analysis includes correlating data structures among a multiplicity of LHD data structures obtained from one or more biological samples.

14. The method of claim 4, wherein the methylation information is used to reveal whether or not a human tissue generated from stem cells or induced pluripotent stem (iPS) cells is in the specific, desired developmental state characteristic of a normal human tissue sample.

15. The method of claim 5, wherein the methylation and SNP information is used to reveal whether or not a human tissue generated from stem cells or iPS cells is in the specific, desired developmental state characteristic of a normal human tissue sample with a similar germline haplotype structure.

16. The method of claim 5, wherein the LHD methylation and SNP information is used to reveal the rich heterogeneity of normal or diseased neural tissue, by employing a ternary data representation in a markov model for the methylation status of cytosines, in order to enable the LHD analysis of brain DNA containing cytosine, 5-methylcytosine as well as 5-hydroxymethylcytosine.


SEQUENCE LISTING (16 sequences)

SEQ ID NO: 1 - DNA, 76 bp, Homo sapiens
  modified_base (8)..(8): m5c
atttagangatagtgagaggatgattgagattgatgagatggattagatgttagattngagtagtatggattagtt

SEQ ID NO: 2 - DNA, 53 bp, Homo sapiens
  modified_base (30)..(30): m5c
atgttagattagtagtggatagatgtaganggatagttatgatgtggattgaa

SEQ ID NO: 3 - DNA, 76 bp, Homo sapiens
  modified_base (8)..(8): m5c
atttagangatagtgagaggatgattgagattgatgagacggattagatgttagattngagtagtatggattagtt

SEQ ID NO: 4 - DNA, 53 bp, Homo sapiens
atgttagattagtagtggatagatgtagatggatagttatgatgtggattgaa

SEQ ID NO: 5 - DNA, 76 bp, Homo sapiens
  modified_base (22)..(22): m5c
atttagatgatagtgagaggangattgagattgatgagatggattagatgttagatttgagtagtatggattagtt

SEQ ID NO: 6 - DNA, 53 bp, Homo sapiens
  modified_base (16)..(16): m5c
atgttagattagtagnggatagatgtaganggatagttatgatgnggattgaa

SEQ ID NO: 7 - DNA, 76 bp, Homo sapiens; identical to SEQ ID NO: 5
  modified_base (22)..(22): m5c

SEQ ID NO: 8 - DNA, 53 bp, Homo sapiens
  modified_base (16)..(16): m5c
atgttagattagtagnggatagatgtagatggatagttatgatgnggattgaa

SEQ ID NO: 9 - DNA, 35 bp, Homo sapiens
  modified_base (8)..(8): m5c
atttagangatagtgagaggatgattgagattgat

SEQ ID NO: 10 - DNA, 53 bp, Homo sapiens; identical to SEQ ID NO: 2
  modified_base (30)..(30): m5c

SEQ ID NO: 11 - DNA, 53 bp, Homo sapiens; identical to SEQ ID NO: 4

SEQ ID NO: 12 - DNA, 35 bp, Homo sapiens
atttagatgatagtgagaggatgattgagattgat

SEQ ID NO: 13 - DNA, 53 bp, Homo sapiens
  modified_base (16)..(16): m5c
atgttagattagtagnggatagatgtaganggatagttatgatgtggattgaa

SEQ ID NO: 14 - DNA, 35 bp, Homo sapiens
  modified_base (22)..(22): m5c
atttagatgatagtgagaggangattgagattgat

SEQ ID NO: 15 - DNA, 53 bp, Homo sapiens; identical to SEQ ID NO: 6
  modified_base (16)..(16): m5c

SEQ ID NO: 16 - DNA, 53 bp, Homo sapiens
  modified_base (16)..(16): m5c
atgttagattagtagnggatagatgtagatggatagttatgatgcggattgaa